(19) United States
(12) Patent Application Publication
(10) Pub. No.: US 2025/0292091 A1
(43) Pub. Date: Sep. 18, 2025

(54) Systems and Methods for Dynamic Neural Network Enhancement and Adaptive Edge Computing

(71) Applicant: VEEA INC., New York, NY (US)

(72) Inventor: Clint SMITH, New York, NY (US)

(21) Appl. No.: 19/075,637

(22) Filed: Mar. 10, 2025

Related U.S. Application Data
(60) Provisional application No. 63/565,792, filed on Mar. 15, 2024.

(51) Int. Cl. G06N 3/082; G06N 3/048

(52) U.S. Cl. CPC G06N 3/082; G06N 3/048

(57) ABSTRACT

Systems and methods for adaptive edge computing using artificial intelligence (AI) include monitoring real-time accuracy of a neural network by using a feedback loop configured to detect changes in inference accuracy and dynamically adjusting the structure of the neural network by adding or removing hidden layers based on monitored error rates and predetermined computational constraints. A Kalman gain computation determines neural network weight adjustments based on monitored error rates. Weight matrices undergo incremental updates derived from these adjustments. Incremental weight adjustments remain stored in memory to enable low-bandwidth model updates. The neural network stores inference results and refined weights in an inference result database. Pre-trained models periodically receive incremental updates based on stored adjustments. Predictive holistic inference logic (PHIL) applied to stored inference results improves the accuracy of the inference results.

### RELATED APPLICATIONS

This application claims the benefit of priority to U.S. Provisional Application No. 63/565,792 entitled “Artificial Intelligence Edge Middleware” filed Mar. 15, 2024, the entire contents of which are hereby incorporated by reference for all purposes.

### BACKGROUND

The growing complexity of distributed computing systems has necessitated advancements in methodologies and architectures for managing computational resources, data processing, and communication networks. Edge computing has emerged as a decentralized approach to augment traditional cloud-based systems by bringing computational resources closer to data sources. This paradigm seeks to address challenges such as reducing latency, improving bandwidth efficiency, and enhancing real-time decision-making capabilities by offloading tasks to devices or nodes at the network edge.

AI techniques, particularly those utilizing neural networks, have demonstrated significant utility in various domains, including data analysis, pattern recognition, and automated decision-making. Neural networks, such as CNNs and DNNs, consist of multiple layers of interconnected processing nodes, each performing transformations on input data to generate meaningful outputs. These networks rely on training processes to adjust weight parameters and biases, allowing the models to adapt to complex datasets and generate accurate predictions or inferences.

Dynamic environments, such as edge computing networks, introduce unique challenges for the deployment and operation of AI models. Constraints on computational resources, such as processing power, memory, and energy, necessitate efficient optimization techniques to achieve consistent performance. In addition, the dynamic nature of network conditions, including varying workloads, changes in topology, and fluctuating resource availability, requires adaptive methodologies to maintain system efficiency.

Enhancement techniques, such as those incorporating feedback-based algorithms, are being increasingly used to refine the performance of AI systems in real-time. Kalman filters, for example, provide a robust framework for estimating and adjusting parameters in systems with noise or uncertainty. These filters have been applied in various computational contexts to improve the precision of predictive models by iteratively updating parameters based on incoming data.

The integration of neural networks with advanced enhancement techniques and feedback mechanisms has potential applications in managing distributed computing environments. These systems may dynamically adapt to changing conditions, improve resource allocation, and improve decision-making processes. As technologies continue to advance, addressing the complexities of distributed and resource-constrained environments remains an area of ongoing development.

### SUMMARY

The various aspects include methods for adaptive edge computing using artificial intelligence (AI), which may include monitoring real-time model accuracy of a neural network by using a feedback loop configured to detect changes in inference accuracy, dynamically adjusting a structure of the neural network by adding or removing hidden layers based on monitored error rates and predetermined computational constraints, computing a Kalman gain based on monitored error rates, and determining weight adjustments for the neural network based on the computed Kalman gain, incrementally updating weight matrices of the neural network based on the determined weight adjustments, storing incremental weight adjustments of the neural network in memory for performing low-bandwidth model updates, storing inference results generated by the neural network and refined weights in an inference result database, periodically updating pre-trained models associated with the neural network based on the stored incremental weight adjustments, and applying predictive holistic inference logic (PHIL) to the inference results stored in the inference result database to produce enhanced inference accuracy.

In some aspects, monitoring real-time model accuracy by using the feedback loop includes tracking model performance metrics by repeatedly analyzing inference accuracy in response to changes in real-time network conditions experienced by the neural network. In some aspects, the methods may include comparing predicted outputs generated by the neural network to actual network behavior to identify deviations between predicted outputs and actual network behavior, and triggering recalibration of the neural network in response to determining that an identified deviation exceeds a predefined accuracy threshold value. In some aspects, the methods may include dynamically adjusting the predefined accuracy threshold value based on measured variability in network conditions to reduce the frequency of recalibrations of the neural network.

In some aspects, dynamically adjusting the structure of the neural network by adding or removing hidden layers based on the monitored error rates and predetermined computational constraints may include analyzing neuron activation patterns of at least one hidden layer of the neural network to determine whether the at least one hidden layer contributes to inference accuracy, and improving computational efficiency of the neural network by removing the at least one hidden layer from the structure of the neural network in response to determining that the at least one hidden layer does not substantially contribute to inference accuracy.

In some aspects, analyzing neuron activation patterns of the at least one hidden layer may include analyzing neuron activation levels to determine whether the at least one hidden layer consistently exhibits low activation during inference operations, and removing the at least one hidden layer from the neural network structure in response to determining that the at least one hidden layer consistently exhibits low activation. In some aspects, dynamically adjusting the structure of the neural network by adding or removing hidden layers based on the monitored error rates and predetermined computational constraints may include implementing a self-pruning mechanism configured to identify and remove neurons from hidden layers exhibiting low activation gradients.

In some aspects, dynamically adjusting the structure of the neural network by adding or removing hidden layers based on the monitored error rates and predetermined computational constraints may include replacing an activation function used by neurons within hidden layers with an alternative activation function selected from a rectified linear unit (ReLU) or a Leaky ReLU to increase learning efficiency. In some aspects, computing the Kalman gain based on monitored error rates and determining weight adjustments based on the computed Kalman gain may include computing the Kalman gain by integrating weighted error estimates derived from real-time inference feedback, and refining weight adjustments of the neural network based on the computed Kalman gain to improve convergence rates during inference operations. In some aspects, storing incremental weight adjustments of the neural network in memory for performing low-bandwidth model updates further may include applying federated learning techniques to distribute incremental weight differentials instead of distributing full neural network model updates.

In some aspects, updating pre-trained models associated with the neural network periodically based on stored incremental weight adjustments may include incorporating newly observed network traffic patterns and associated device behavior into an existing architecture of the pre-trained models, and executing asynchronous updates of the pre-trained models to maintain uninterrupted real-time inference operations. In some aspects, applying predictive holistic inference logic (PHIL) to the inference results stored in the inference result database to produce enhanced inference accuracy may include integrating multiple inference sources associated with the neural network to refine model predictions through a consensus-based approach.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1 is a component block diagram illustrating an artificial neuron model in accordance with some embodiments.

FIG. 2 is a component block diagram illustrating a multi-layer artificial neural network in accordance with some embodiments.

FIG. 3 is a component block diagram illustrating an adaptive neural network model incorporating a Kalman filter in accordance with some embodiments.

FIGS. 4A-4H are component block diagrams illustrating a complex adaptive neural network model that uses multiple Kalman filter sub-algorithms in accordance with some embodiments.

FIG. 5 is a component block diagram illustrating the key factors involved in edge compute node optimization, in accordance with some embodiments.

FIG. 6 is a process flow diagram illustrating a method for network configuration using neural networks and Kalman filters in accordance with some embodiments.

FIG. 7 is a process flow diagram illustrating a method for dynamic network management in a computing device in accordance with some embodiments.

FIG. 8 is a process flow diagram illustrating a method for managing an edge computing network in accordance with some embodiments.

FIG. 9 is a process flow diagram illustrating a method for enhancing a deep neural network using a Kalman filter and PHIL for dynamic learning and adaptation in accordance with some embodiments.

FIGS. 10A-10F are process flow diagrams illustrating a method 1000 for AI-driven adaptive edge computing in accordance with some embodiments.

FIG. 11 is a process flow diagram illustrating a method 1100 for dynamically configuring an edge computing network in accordance with some embodiments.

FIG. 12 is a process flow diagram illustrating a method 1200 for enhancing edge computing systems using neural networks and dynamic decision-making in accordance with some embodiments.

FIG. 13A is a component block diagram that illustrates an example edge computing system suitable for implementing the various embodiments.

FIG. 13B is a component block diagram that illustrates an edge device that interconnected modules designed for specialized and general-purpose computations in distributed edge computing systems.

FIG. 14 is a component diagram of server suitable for implementing some embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

In overview, the various embodiments include methods of integrating and using advanced artificial intelligence (AI) technologies and techniques that facilitate proactive and real-time decision-making to enhance, augment, or optimize (herein collectively “enhance”) edge computing infrastructures for a wide range of applications. Some embodiments may include a highly adaptive and modular AI system capable of self-tuning, self-optimization, rapid modification or reconfiguration, and/or continual learning. The embodiments may overcome various technical challenges associated with managing resource-constrained edge nodes in a dynamic environment by using AI techniques and technologies for adaptive, real-time decision-making. In some embodiments, the methods may include dynamically adjusting the size and complexity of a neural network in real-time by adding or removing layers based on a confidence level (or performance value, etc.) to refine the output, enhance processing efficiency, and/or adapt to resource constraints. In some embodiments, the methods may include using a Kalman filter to adjust or fine-tune the weights of individual nodes within the neural network layers for real-time optimization and better alignment with desired outputs. In some embodiments, one or more weights may be set to zero to remove one or more hidden layers from the neural network.

Further aspects may include a computing device (edge computing device) having a processor configured with processor-executable instructions to perform various operations corresponding to the methods discussed above. Further aspects may include a computing device (edge computing device) having various means for performing functions corresponding to the method operations discussed above. Further aspects may include a non-transitory processor-readable storage medium having stored thereon processor-executable instructions configured to cause a processor to perform various operations corresponding to the method operations discussed above.

The term “neural network” may be used herein to refer to an interconnected group of processing nodes, or neuron models, that operate as a computational framework to perform functions of a computing device or produce inference results. Each processing node may receive input data, perform defined operations to produce an output referred to as activation, and transmit the activation to subsequent nodes. A neural network may include weights associated with the connections between nodes, defining the relationships between inputs and outputs. Adjustments to these weights during a training process may allow the neural network to refine its performance. Training may involve processing tasks with known outcomes, comparing activations to expected outputs, and adjusting weights based on comparisons. After training concludes, the neural network may perform inference using the adjusted weights to process new tasks.

The term “inference” may be used herein to refer to a process performed at runtime by a neural network to generate output values, also referred to as activations or inference results. Inference may involve traversing the network along a forward computational path, where input data passes through processing nodes to produce one or more output values.

The term “deep neural network” (DNN) may be used herein to refer to a neural network including multiple layers organized hierarchically. In a DNN, activations from earlier layers may serve as inputs for subsequent layers, creating a distributed computational chain across a population of processing nodes. DNNs may include activation functions such as rectified linear units (ReLU) applied between layers to introduce non-linear transformations. The input layer may accept raw data, the output layer may produce results, and intermediate layers may perform feature extraction or data transformations.

The term “layer” in a neural network may be used herein to refer to a set of interconnected processing nodes that receive inputs from preceding layers and provide outputs to subsequent layers. Each layer may have multiple inputs and outputs. Although embodiments may describe layers with single inputs or outputs for simplicity, the described operations may apply to multiple inputs and outputs.

Each layer in a neural network may have multiple inputs and thus multiple previous or preceding layers. Said another way, multiple layers may feed into a single layer. For ease of reference, some of the embodiments are described with reference to a single input or single preceding layer. However, it should be understood that the operations disclosed and described in this application may be applied to each of multiple inputs to a layer and multiple preceding layers.

The term “recurrent neural network” (RNN) may be used herein to refer to a neural network designed for processing sequence data. Unlike feedforward networks, an RNN may include cycles or loops in its architecture, allowing it to retain information about prior inputs. This ability may help the RNN process tasks where the order or context of input data affects the outcome.

The term “convolutional neural network” (CNN) may be used herein to refer to a deep neural network employing convolution operations to process input data. A CNN may include layers that use filters to detect patterns in spatial data, such as images or videos. Each layer may extract increasingly complex features by applying convolution operations and pooling techniques. The network may generate inference results such as classifications, object detections, or feature maps.

The term “network configuration” may be used herein to refer to the setup of network devices and software to manage data flow and communication. This process may include configuring routing protocols, assigning node roles, allocating bandwidth, and implementing security policies. Network configuration may apply to both physical devices and software components to meet operational demands.

The term “processing system” may be used herein to refer to one or more processors, including multi-core processors, organized to perform computational functions. A processing system may reside within a computing device or as part of a system-on-chip and may execute software to perform operations described herein.

The term “computing device” may be used herein to refer to systems equipped with processors and communication capabilities, such as personal computers, edge devices, smartphones, IoT devices, or servers. A computing device may execute software applications and exchange data with other systems.

The term “edge device” may be used herein to refer to a computing system deployed at the network edge with capabilities for processing data locally and communicating with consumer devices or network components. Examples may include access points, routers, gateways, and devices supporting edge computing techniques.

The term “container” may be used herein to refer to a software component supporting virtualization and resource abstraction. A container may isolate computing resources and operate independently from underlying hardware while executing software applications.

The terms “component,” “system,” and the like may be used herein to refer to a computer-related entity, such as hardware, firmware, a combination of hardware and software, software, or software during its execution. These entities may be configured to carry out specific operations or functionalities. For example, a component may encompass a process operating on a processor, a processor itself, an object, an executable, a thread of execution, a program, or a computing device. As an illustrative example, both an application running on a computing device and the computing device itself could be termed a component. One or more components may be situated within a process and/or thread of execution and/or may be localized on a single processor or core or distributed across multiple processors or cores. In addition, these components may execute from various non-transitory computer-readable media having various instructions and/or data structures stored thereon. Components may communicate by way of local and/or remote processes, function or procedure calls, electronic signals, data packets, memory read/writes, and other known computer, processor, and/or process-related communication methodologies.

The term “system on chip” (SOC) may be used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high speed communication circuitry and packaged in close proximity, such as on a single backplane, single motherboard or in a single wireless device. The proximity of the SOCs facilitates high speed communications and the sharing of memory and resources.

The term “multicore processor” may be used herein to refer to a single integrated circuit (IC) chip or chip package that contains two or more independent processing cores (e.g., CPU core, IP core, GPU core, etc.) configured to read and execute program instructions. A SOC may include multiple multicore processors, and each processor in a SOC may be referred to as a core. The term “multiprocessor” may be used herein to refer to a system or device that includes two or more processing units configured to read and execute program instructions.

The term “computing mesh” may be used herein to refer to distributed computing frameworks connecting resources across multiple nodes. A computing mesh may dynamically allocate resources and execute applications across interconnected components.

The term “edge computing” may be used herein to refer to computational techniques that offload processing tasks to devices or servers at the edge of a network. Edge computing may reduce latency and optimize resource use for applications requiring real-time data analysis.

An edge computing system may integrate remote cloud servers and proximate edge devices to form a collaborative computing environment that may enhance the performance, latency, and energy consumption characteristics of user computing devices. Traditional cloud servers may provide substantial computational and storage capacities but may introduce propagation delays when transmitting large volumes of data due to their remote geographical deployment. In contrast, edge devices may reduce these propagation delays by operating closer to the user but may have more limited computational and storage capacities. The processing and storage limitations of an edge device may be offset by its lower access times and latency characteristics when compared to a cloud server. An edge computing system may intelligently and dynamically balance tradeoffs between performance and latency by distributing computational tasks across cloud and edge resources.

In some embodiments, the edge computing system may balance tradeoffs such as performance, latency, and power consumption by implementing a computing mesh, an application mesh, or a connectivity mesh. The edge computing system may include multiple edge devices connected through wired or wireless communication links, forming a computing mesh that enables resource sharing among edge devices. When multiple edge devices in a computing mesh are served by the same cloud server, the system may allocate cloud computational resources dynamically based on the workload, local computation capacities, and performance requirements of each edge device.

Edge computing may allow applications to execute at the network's edge through computing platforms that interact with user devices and sensors. This may reduce latency, increase throughput, improve contextual and location awareness, decrease backhaul data transmission, and enhance security and isolation.

Edge computing nodes may form the structural foundation of edge computing by providing localized processing and storage capabilities. These nodes may function as computing platforms with middleware components that manage distributed processing and resource allocation. By shifting computing tasks from the cloud or upstream services to edge computing nodes, edge computing may provide context-aware data processing and reduce reliance on centralized infrastructure.

Edge computing nodes may operate independently or as part of a distributed ecosystem interconnected through wired or wireless communication links. This interconnected structure may support coordinated resource sharing and adaptive workload distribution.

Edge computing nodes may function as standalone devices or as components of a distributed ecosystem. These nodes may interact by sharing backhaul connections, coordinating resource usage, or running applications accessed by other nodes.

By executing applications and functions at the network's edge rather than in a remote data center, edge computing nodes may reduce latency and improve processing efficiency. However, operating at the network's edge may introduce resource constraints, including limitations in processing capacity, memory, storage, power, and backhaul connectivity.

A fixed configuration of an edge computing node with stable applications and connectivity may provide consistent performance. However, edge computing environments may be dynamic, requiring configuration adjustments that may be performed manually rather than through automated orchestration.

Elastic edge computing environments may involve continuous changes, including node additions and removals, backhaul modifications, upstream network resource reallocations, node resource adjustments, and inter-node resource distribution. AI integrated into edge computing nodes may support adaptive management, addressing configuration and application delivery challenges in such environments.

Some embodiments may include a processing system with one or more processors configured to manage an edge computing environment using AI. The processing system may receive real-time network data (e.g., resource utilization metrics, network topology information, connectivity status, etc.) from a plurality of edge computing nodes, detect a change in the edge computing environment (e.g., a node addition, a node removal, a backhaul modification, an upstream resource reallocation, etc.), classify a current network state based on the detected change and a set of predefined performance criteria, generate a resource allocation strategy for enhancing workload distribution across the plurality of edge computing nodes, and transmit configuration updates based on the resource allocation strategy.

In some embodiments, the processing system may generate the resource allocation strategy by determining a workload assignment for each edge computing node based on the resource utilization metrics and connectivity status and selecting a backhaul resource allocation for each edge computing node based on a latency threshold and bandwidth availability. The processing system may monitor the post-adjustment performance of the edge computing environment and refine a machine learning model based on the observed performance. Refining the machine learning model may include adjusting at least one model parameter to improve future resource allocation strategies.

Edge computing nodes may be classified based on their operational roles. A node group may represent a collection of nodes, and a master node group may include nodes with backhaul connectivity. Similarly, applications may be categorized into application groups, and resource availability may be classified based on internal resources, local network resources, upstream network resources, or off-network resources such as the internet. Additional classifications may be established based on network requirements. Each classification may include attributes for identification and management. For example, a backhaul group may distinguish between wired and wireless connections and whether a connection supports inter-node communication.

In some embodiments, the processing system may dynamically allocate network resources in an edge computing environment. The processing system may receive operational data (e.g., network traffic patterns, device attributes, resource availability information) from a plurality of edge computing nodes, classify each edge computing node into a corresponding node group based on the operational data, classify each application executed on the plurality of edge computing nodes into an application group based on execution priority and resource requirements, assign resource availability classifications to each edge computing node (e.g., internal resources, local network resources, upstream network resources, off-network resources), and allocate computing resources based on the assigned classifications. The processing system may dynamically update at least one of the classifications based on changes in operational data.

AI using neural networks may rely on weights and biases to transform input data into meaningful outputs. Weights may define the influence of input features and biases may adjust the decision boundary of the network. The process of enhancing these parameters may be central to neural network training. During training, optimization/enhancement algorithms such as stochastic gradient descent may iteratively update weights and biases based on loss function gradients to refine the network's predictive accuracy. Once trained, the neural network may perform inference by applying learned parameters to new input data to generate outputs based on patterns identified during training. The accuracy of inference may depend on the quality and distribution of training data, the network's architecture, and the choice of optimization/enhancement techniques.

Neural network learning may extend beyond the initial training phase. As new data and problem domains emerge, continuous learning mechanisms such as online learning, transfer learning, and incremental learning may refine model parameters while preserving previously acquired knowledge. These adaptive techniques may allow neural networks to update their responses dynamically to improve performance in evolving environments.

Weights may include synaptic weights and biases, in which weights determine input influence, and biases adjust neuron activation thresholds.

The Kalman filter may provide a framework for enhancing weights and biases during initial training and continuous learning by leveraging its covariance matrix. These solutions may allow neural networks to refine parameter estimates while adapting to dynamic conditions. Kalman filters may adjust weights and biases independently or in conjunction with other AI architectures. By integrating the Kalman filter, lower-confidence data may be excluded from weight updates, reducing gradient skew and improving convergence efficiency. This filtering process may accelerate the optimization of network parameters by prioritizing higher-confidence data.

In some embodiments, the processing system may be configured to use a Kalman filter to enhance neural network weight updates. The processing system may receive real-time input data (e.g., feature values and corresponding confidence scores), predict an updated weight estimate for at least one neural network parameter using a prior weight estimate and a covariance matrix associated with the Kalman filter, compute a Kalman gain based on the covariance matrix and an error measurement associated with the real-time input data, filter the real-time input data by discarding input data having a confidence score below a predefined threshold, adjust the neural network parameter based on the Kalman gain and the filtered real-time input data, and store the adjusted neural network parameter in memory for subsequent inference operations.

Incremental weight updates may refine neural network performance without requiring full model retraining. Instead of replacing an entire weight set, updates may apply selectively to modified weights, reducing bandwidth consumption and processing overhead. Incremental weight updates may allow seamless integration into an active neural network without requiring power cycles or task interruptions.

In some embodiments, the processing system may perform incremental weight updates by identifying modified weights (e.g., weights differing from a previously stored weight set), determining an update window, applying the modified weights during the update window, and storing the applied weights in memory. The processing system may initiate the next incremental update cycle based on detected changes in network conditions.

AI-based adaptive responses may allow real-time network optimization without requiring predefined policy rules. Artificial neural networks may model and control complex nonlinear systems, such as edge computing networks, by mapping intricate relationships between inputs and outputs.

AI may determine a best-fit configuration rather than an optimal configuration depending on adjustment urgency. A best-fit approach may allow rapid adaptation to new tasks or network configurations, and continuous learning may refine the model toward an optimal configuration.

AI at the network's edge may extend beyond traditional machine learning by addressing large-scale, dynamic network configurations. Unlike conventional approaches, AI may adapt to evolving network topologies influenced by device locality rather than predefined patterns. Dynamic edge networks may exhibit mobility rather than remaining stationary, requiring continuous self-aware adjustments. The variability and time constraints associated with these adjustments may exceed the capacity of predefined policy rules, necessitating real-time adaptation.

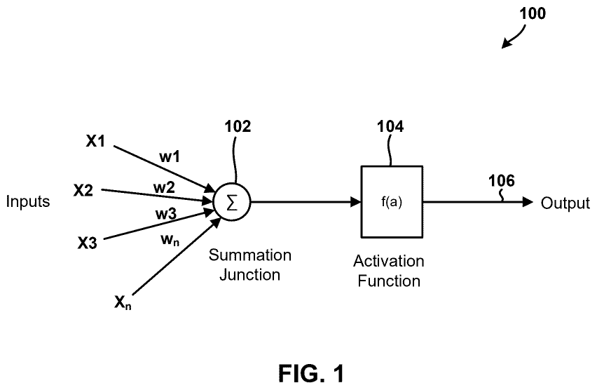

FIG. 1 illustrates an example of a neuron 100, which is a fundamental element of the neural network. The illustrated neuron has multiple inputs, labeled X1 through Xn, that are each associated with a respective weight, w1 through wn. These inputs and weights converge at a summation junction 102 that aggregates the weighted inputs. The resultant sum is then passed to an activation function 104, denoted as f(a), which processes the input to generate an output 106. The activation function 104 serves as a nonlinear transformation to determine the neuron's output in response to its aggregated input. The output 106 may represent the neuron's contribution to the next layer in a neural network or the final output in a single-layer perceptron model.

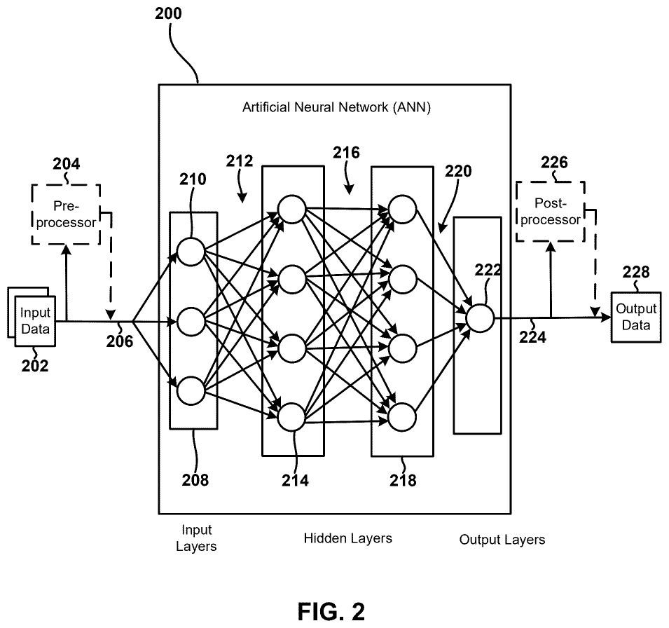

FIG. 2 illustrates the architecture of a multi-layer artificial neural network, including an input layer, hidden layers, and an output layer. Data flows sequentially through the layers via weighted connections to allow the network to process and transform input data into actionable outputs. Each node in FIG. 2 may represent an individual neuron (e.g., neuron 100 illustrated in FIG. 1). The input layer may receive input data, the hidden layers may process this data using nonlinear transformations, and the output layer may produce the final output. The weights and biases of the connections between nodes may be set during a training process to reduce or minimize the error between actual outputs and desired outputs.

In particular, FIG. 2 illustrates an example artificial neural network (ANN) 200 model may include an input layer, one or more hidden layers, and an output layer. In the example, illustrated in FIG. 2, the system includes the ANN 200, input data 202, a pre-processor 204, an input layer 206, interconnections 208 linking neurons between layers, hidden layers 212, 216, and 220, interconnections 222 connecting neurons within the ANN, an output layer 224, a post-processor 226, and output data 228.

The ANN 200 may process input data 202 through interconnected layers, including the input layer 206, hidden layers 212, 216, and 220, and the output layer 224. The network may utilize weighted connections between neurons to perform tasks such as pattern recognition, data classification, or inference. Training the ANN may involve adjusting these weights to optimize accuracy and reduce errors.

Input data 202 may represent raw information provided to the ANN for processing. This data may include numerical, categorical, or multidimensional values, such as sensor readings, image pixels, or network traffic statistics. The input data may serve as the initial information for analysis and may be passed to the pre-processor 204.

The pre-processor 204 may standardize raw input data into a format suitable for the ANN. Preprocessing may involve operations such as normalization, feature extraction, dimensionality reduction, or encoding of categorical data. These operations may improve consistency in data representation and enhance the ANN's ability to identify patterns.

The input layer 206 may include neurons that receive preprocessed data. Each neuron in this layer may correspond to a feature of the input data and may pass information to subsequent layers. The input layer may act as an interface between raw data and the computational processes of the hidden layers.

Interconnections 208 may link neurons in the input layer to those in subsequent layers, representing weighted pathways that determine how each input feature contributes to the ANN's output. These weights may be adjusted during training to optimize performance.

Hidden layers 212, 216, and 220 may hierarchically process the input data. Each hidden layer may apply nonlinear transformations to extract meaningful abstractions, utilizing activation functions such as ReLU, sigmoid, or tanh. These layers may progressively refine the data to uncover higher-level patterns.

The first hidden layer 212 may process raw features received from the input layer and generate intermediate representations. The second hidden layer 216 may refine these representations by emphasizing patterns relevant to the task. The final hidden layer 220 may prepare the data for classification or inference in the output layer.

Interconnections 222 between neurons in adjacent layers may transmit weighted signals. These connections represent the contribution of one neuron's activation to another, and their weights may be iteratively optimized during training to improve predictive accuracy.

The output layer 224 may generate the ANN's final result. Each neuron in the output layer may correspond to a specific outcome, prediction, or decision. For instance, in classification tasks, the output layer may assign probabilities to various categories.

The post-processor 226 may refine the raw outputs of the ANN to produce actionable insights. Operations performed by the post-processor may include scaling probabilities, applying thresholds, or mapping outputs to decision labels. These refinements may prepare results for downstream applications.

Output data 228 may represent the final product of the ANN's processing. This data may include actionable insights, such as classifications, predictions, or control signals, as refined by the post-processor.

A Multilayer ANN (e.g., ANN 200 illustrated in FIG. 2, etc.) may be particularly well suited for addressing problems in application domains involving recognition, classification, and vector quantization. Edge computing may represent a key application domain for such implementations.

The ANN for an edge computing node may execute within a neural processing unit (NPU), which may be implemented as a hardware-based platform or as a software-only platform referred to as NPU-lite.

An NPU may represent a dedicated processor or processing unit integrated within a larger SoC and specifically designed to execute ANN operations. Unlike general-purpose CPUs and GPUs, NPUs may be optimized for parallel computing, enabling efficient data processing for neural networks. By offloading ANN functions to the NPU, computational loads on the CPU and GPU may be reduced, enhancing overall system performance.

The NPU-lite may execute as software running on a local edge computing node, using programming languages such as Python or other suitable languages. Alternatively, the NPU-lite may interact with an NPU residing on another edge computing node or within a cloud-based AI system.

CNNs, a type of DNN, may also be utilized within edge computing nodes for tasks such as classification, application of rules, heuristics, analysis of prior cases, and generating expectations.

Deep neural networks, including CNNs, may address challenges associated with exponentially large parameter spaces by incorporating multiple hidden layers. These hidden layers enable hierarchical feature processing, allowing the network to manage complex input data effectively.

The hidden layers in CNNs may include convolution layers, pooling layers, and fully connected layers. Convolution and pooling layers may serve primarily as feature extractors, analyzing data derived from images, applications, or other functions. Pooling layers may also reduce the dimensionality of feature maps while preserving key attributes. Fully connected layers, typically positioned at the final stage of the network, may perform classification tasks.

CNNs may exhibit two defining characteristics: weight sharing and local connectivity. Weight sharing involves using identical weights across nodes within a layer, enhancing computational efficiency. Local connectivity ensures that each node processes input data from a limited subset of the input vector, enabling the network to focus on localized features and produce outputs related to specific input regions.

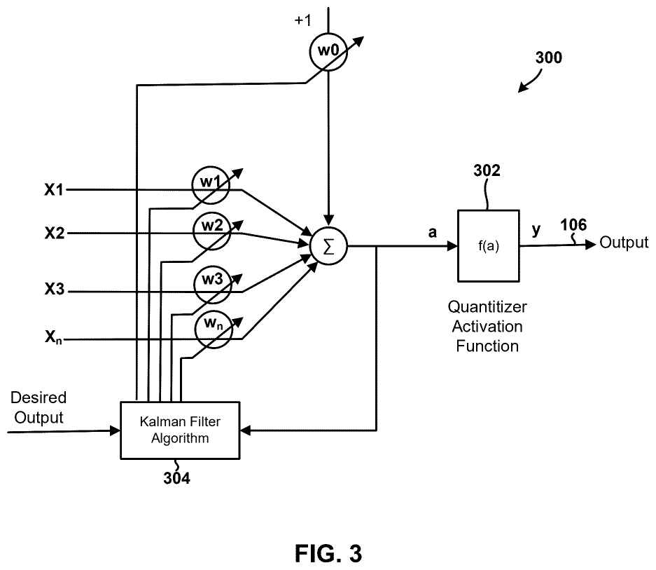

FIG. 3 illustrates an adaptive neural network model 300 configured to process multiple inputs, labeled X1 through Xn, each associated with an adaptive weight (e.g., w1 through wn) and an overall weight of w0. These weighted inputs are aggregated at a summation junction, represented by the summation symbol (Σ). The resultant sum, denoted as ‘a,’ is passed through a quantizer activation function 302, represented as f(a), which transforms the input into a quantized output 106. This output may correspond to the network's decision, classification, or other inference result.

The model 300 incorporates a Kalman filter algorithm component 304 as a feedback mechanism. The Kalman filter 304 receives both the actual output from the activation function 302 and the desired output. By comparing these outputs, the Kalman filter dynamically adjusts the weights (e.g., w0 through wn) to reduce the difference between the actual and desired outputs. This feedback process enhances the network's precision by iteratively refining the weights, allowing the system to improve its accuracy and efficiency over time.

Model 300 also has the ability to reduce training time as well as provide selective adjustments to specific nodes or layers. For example the weights w0 through wn can be preset to initiate training, provide a trained model, or provide updates to the existing weights.

The weights can be set so they do not change allowing for trained model to be deployed in multiple diverse locations all providing similar responses based on inputs. The weights can be updated either on a whole model, individual layer or layers or on selective nodes. The weights can also be dynamically updated in real time based on the feedback, recursive feedback process either on a system, layers or nodes. Through multiple methods of updating node and layer weights the AI network can be optimized for the desired objective.

The proposed weight adjustments derived my PHIL may not be implemented or partially implemented or fully implemented based on the desired objective. The updated weights from PHIL can be provided to an new or existing model for enhanced training. The output of PHIL can be a flat file, a matrix, or any format representing the weighted values for each layer and or node allowing for an optimized approach to training models.

The weights and or covariant matrix used by PHIL can be updated via an external source for providing a revised model. The updates could be for the entire model, individual layer or layers, or for a specific node, nodes or set of nodes depending on what updates are needed. Though performing selective updates a revised model can be efficiently updated in real-time or near real time providing a method of improving AI models that allowed for a federated learning process.

FIG. 3 exemplifies the functionality of a single neuron, similar to those present in a CNN. Each input undergoes a weighting process before aggregation at the summation junction. The Kalman filter algorithm determines these weights by analyzing expected versus actual outputs. Inputs with low confidence or poor data quality may be assigned reduced weights or even excluded to reduce or minimize their impact on the output. This may balance noise in the decision-making process while retaining sufficient information for robust inferences.

The Kalman filter algorithm may allow continuous learning within the model. By iteratively adjusting the weights in real time, the neural network may adapt to changing conditions and incorporate new data into its processing pipeline.

The model 300 may also operate as part of a fuzzy logic system. Prior to quantization, the signal represented by ‘a’ may exist as a non-quantized value, which may vary continuously within a specified range, such as 0 to 1 or −1 to 1. These non-quantized values may be interpreted as fuzzy logic states, which may inform more complex decision-making processes. Such values may also serve as inputs for additional neurons to allow for the representation of multiple states before rendering a final quantized output suitable for external actions.

In the context of deeper neural architectures, models with three or more hidden layers may be classified as DNNs. FIG. 2 depicts a basic example of a DNN architecture in which layered relationships between neurons enable the network to process data hierarchically. During training, these relationships may be reinforced through backpropagation. Following training, the network applies the learned relationships to predict outputs based on new inputs.

DNNs may operate in various configurations, including centralized, decentralized, and hybrid models. A centralized DNN may involve training in a cloud environment using diverse data sources. A decentralized DNN may allow nodes to train locally, preserving data privacy. A hybrid DNN may combine localized training at individual nodes with periodic synchronization to incorporate broader knowledge.

An ANN may process input data to produce decisions or predictions by analyzing patterns and relationships within the data. The ANN may adjust its internal parameters during training to refine outputs and align them with desired results.

Inference refers to applying live data to a trained AI model to generate predictions or solve specific tasks. During inference, the AI model may compare real-time input data to patterns and relationships established during training to generate actionable outputs. In the training phase, the DNN computes relationships within the training examples and establishes weights that connect neurons. These weights allow the DNN to interpret new input data effectively during inference.

Various inference methods may be used in ANNs, such as probabilistic inference, classical inference, and predictive holistic inference logic (PHIL). Probabilistic inference may analyze past patterns and predict future outcomes using probability theory. Classical inference may apply rule-based systems derived from historical data. PHIL may enhance inference through the integration of a convolutional matrix and a Kalman filter.

The PHIL inference method may be particularly suitable for dynamic edge computing environments, where network configurations and application domains frequently evolve. This method may adjust weights and biases continuously to adapt to changing conditions.

Edge computing systems may utilize different inference methodologies, including real-time, batch, and streaming inference. Real-time inference may process data with minimal latency for time-sensitive applications. Batch inference may analyze data in groups for applications with relaxed latency requirements. Streaming inference may continuously process incoming data to provide ongoing insights.

The PHIL inference process may include several components, such as a data source, a machine learning model, an inference engine, and a deployment platform. The data source may represent the content analyzed by the AI. The machine learning model may be trained to recognize specific patterns to enhance inference outcomes. The inference engine may apply the trained model to new data. The deployment platform may serve as the environment for hosting and executing AI applications.

The inference engine in PHIL may operate within the DNN and contribute to adjusting weights and biases. The engine may apply forward projection to derive new insights from existing data and backward projection to confirm alignment between outputs and expected results. These projections may refine the inference process.

Training and learning in a DNN may involve ongoing processes, incorporating positive and negative reinforcement to improve performance. Updating weights during reinforcement may refine the model and adapt it to new data.

The quality and quantity of training data may influence the inference accuracy of a DNN. Insufficient data or training duration may result in suboptimal outputs. Reinforcement techniques may mitigate such limitations and enhance overall performance.

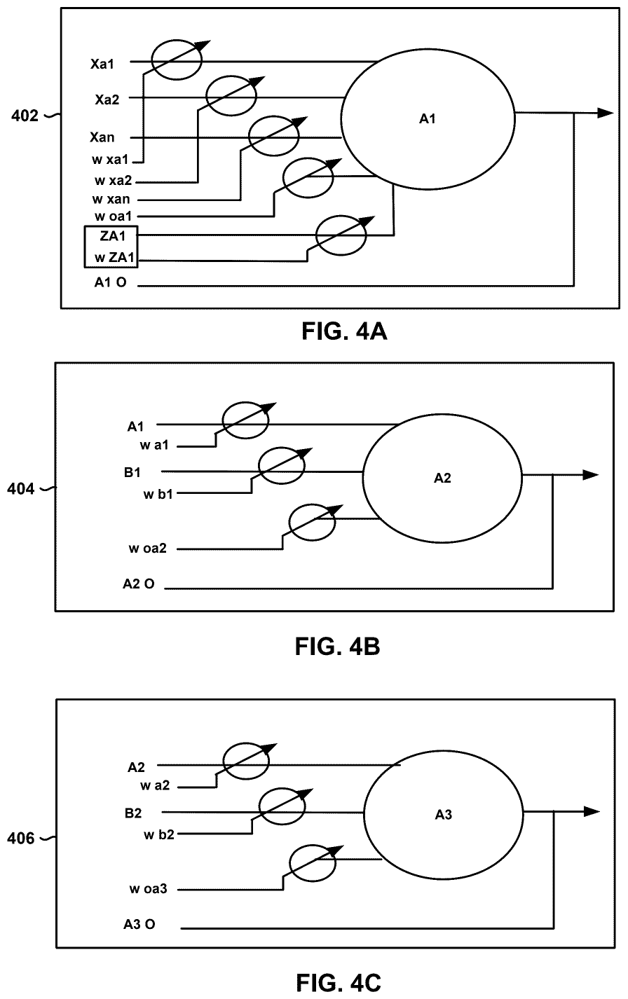

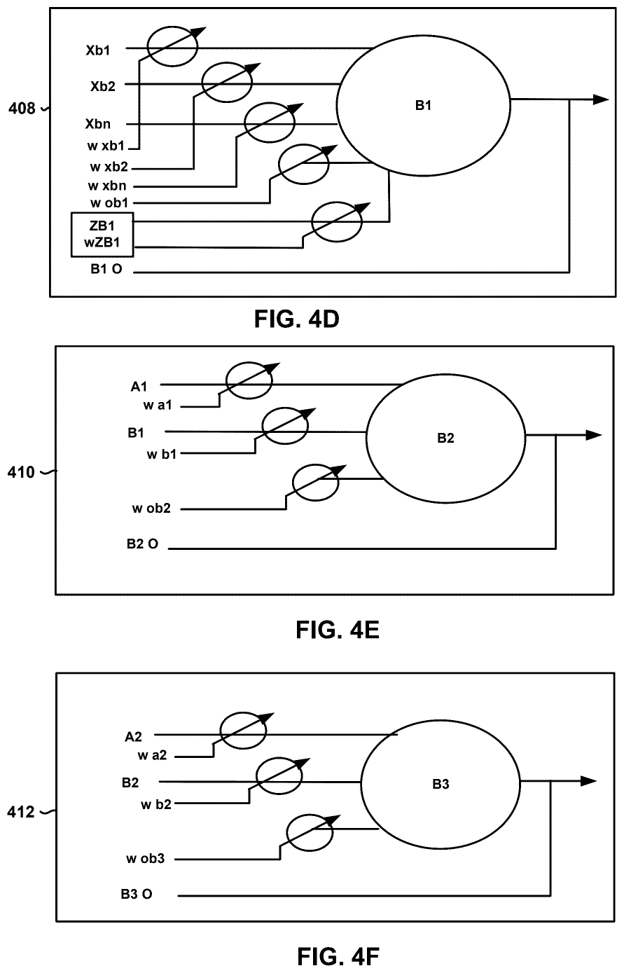

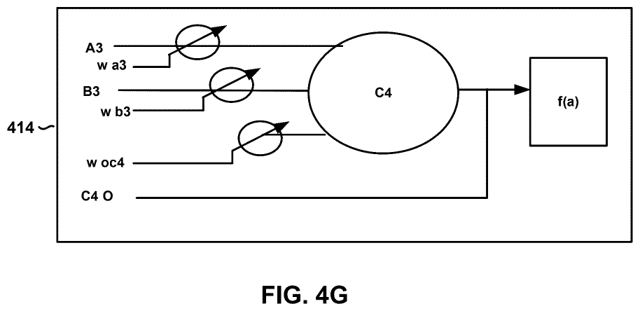

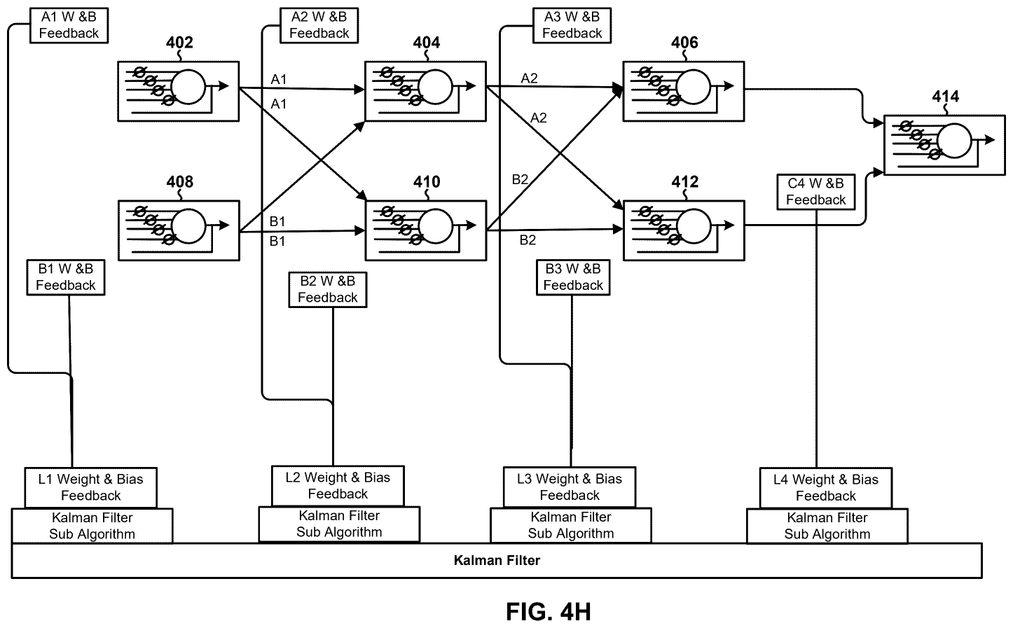

FIGS. 4A-4H illustrate an adaptive neural network model configured to incorporate multiple Kalman filter sub-algorithms for dynamic learning and optimization in accordance with some embodiments. The network structure includes multiple interconnected layers, each containing neurons represented as circles. Weighted connections link these neurons, affecting the strength and flow of signals as data progresses through the network. The Kalman filter sub-algorithms may adjust these weights in response to comparisons between actual outputs and desired results. This iterative adjustment process may improve the network's performance by refining its response to input data based on real-time analysis.

In FIG. 4A, illustrate PHIL for a single node. The input layer 402 processes signals which could be Xₐ₁ through Xₐₙ as initial inputs. Additional inputs include the possible inclusion of ZA1 which is the output from a previous layer and with the associated weight of wZA1, only one possible layer is shown for ease of illustrative purposes. The A10 is illustrates the output of A1, A10 is then used as input to the next layer in the neural network. A10 is also provides the feedback loop used as an input to the Kalman module for that particular node and or layer.

Each input to A1 is multiplied by a corresponding weight (wₓₐ₁ through wₓₐₙ) provided either initially from the training process or from the Kalman Filter module 304. The weight woa is and additional weight which can be applied to the individual node. The corresponding weights for each input can be static providing a trained system that can be consistent with other similarly trained models. The corresponding weights can be semi-static where updates to the model from a master trained model can be used to update the local weights either on a whole system or on a single layer of the neural network. The corresponding weights can also be dynamically updated based on local real world events providing weights which are dynamically adjusted/tuned to provide the optimal solution based on the inputs and the desired outcome parameters for the desired function.

In FIG. 4A the outputs of the various inputs multiplied by the respective weights are then summed at a junction. The resulting summation is passed to neuron A1, where it undergoes additional processing to generate an output. Feedback mechanisms can dynamically modify the weights and biases associated with these inputs to refine the network's response to improve performance and precision in processing subsequent data.

FIG. 4B illustrates the interaction between two layers where neuron A1 and B1 are in one layer and neuron A2 is in another. Only two neuron inputs are shown in FIG. 4B for ease of illustration. However, there can be one input or multiple inputs for A2 depending on the model and applicaiton. Outputs from A1 are scaled by a corresponding weight (wₐ₁) and outputs from B1 are scaled by a corresponding weight (w_{b1}). The corresponding overall node weight for A2 (w_{Oa2}) along with scaled inputs from nodes A1 and B1 are fed into node A2. These weighted signals are then summed and processed by neuron A2 to produce an output A20. Feedback mechanisms, PHIL, can dynamically adjust the weights to refine the outputs and align them with the desired results to improve the network's overall processing accuracy. Alternatively the proposed weight adjustments can be made my PHIL but not implemented or partically implemented or fully implemented based on the desired objective. The updated weights from PHIL can be provided to an new or existing model for enhanced training as part of a transfer learning process. The output of PHIL can be a flat file or any format representing the weights and or covariant matrix values for each layer and or node allowing for an optimized approach to training models.

FIG. 4C extends the network by introducing neuron A3 as an additional processing layer in the network. Outputs from neurons A2 and B2 are scaled by respective weights (wₐ₂, w_{b2}) along with the overall node weight for A3 (w_{Oa3}) are combined and fed into a summation point. The resulting sum is processed by neuron A3 to generate its output A30. Feedback mechanisms can store and or dynamically adjust the all weights or selective weights dynamically to maintain efficient signal flow and support continuous learning across the layers.

FIG. 4D illustrates the second input layer 408, which could process signals Y_{b1} through Y_{bn}. Additional inputs include the possible inclusion of ZB1 which is the output from a previous layer with the associated weight of wZB1, only one possible layer is shown for ease of illustrative purposes. The B10 is illustrates the output of B1, B10 is then used as input to the next layer in the neural network. B10 is also provides the feedback loop used as an input to the Kalman module for that particular node and or layer.

Each input to B1 is directed to neuron B1 for processing. Each input is scaled or multiplied by a corresponding weight (w_{xb1} through w_{xbn}) provided initially from the training process or from the Kalman Filter module 304. The weight wob1 is an additional weight which can be applied to the individual node. The corresponding weights for each input can be static providing a trained system that can be consistent with other similarly trained models. The corresponding weights can be semi-static where updates to the model from a master trained model can be used to update the local weights either on a whole system or on a single layer of the neural network. The corresponding weights can also be dynamically updated based on local real world events providing weights which are dynamically adjusted/tuned to provide the optimal solution based on the inputs and the desired outcome parameters for the desired function.

In FIG. 4D the outputs of the various inputs multiplied or scaled by the respective weights are then summed at a junction. The resulting summation is passed to neuron B1, where it undergoes additional processing to generate an output. Feedback mechanisms can dynamically modify the weights and biases associated with these inputs to refine the network's response to improve performance and precision in processing subsequent data

Alternatively the proposed weight adjustments can be made my PHIL but not implemented or partically implemented or fully implemented based on the desired objective. The updated weights from PHIL can be provided to an new or existing model for enhanced training. The output of PHIL can be a flat file or any format representing the weights and or covariant matrix values for each layer and or node allowing for an optimized approach to training models as part of a transfer learning process.

FIG. 4E extends the network by introducing neuron B2, which integrates outputs from neurons A1 and B1. The signals from these neurons are scaled by their respective weights, combined at a summation point, and processed by B2. Feedback mechanisms continuously adjust the weights and biases to align the network's outputs with expected results.

FIG. 4E illustrates the interaction between two layers where neuron A1 and B1 are in one layer and neuron B2 is in another. Only two neuron inputs are shown in FIG. 4E for ease of illustration. However, there can be one input or multiple inputs for B2 depending on the model and applicaiton. Outputs from A1 are scaled by a corresponding weight (wₐ₁) and outputs from B1 are scaled by a corresponding weight (w_{b1}). The corresponding overall node weight for B2 (w_{Oa2}) along with scaled inputs from nodes A1 and B1 are fed into node B2. These weighted signals are then summed and processed by neuron B2 to produce an output B20. Feedback mechanisms, PHIL, can dynamically adjust the weights to refine the outputs and align them with the desired results to improve the network's overall processing accuracy. Alternatively the proposed weight adjustments can be made my PHIL can be partially implemented, fully implemented or not implemented based on the desired objective. The updated weights from PHIL can be provided to a new or existing model for enhanced training. The output of PHIL can be a flat file or any format representing the weights and or covariant matrix values for each layer and or node allowing for an optimized approach to training models.

FIG. 4F extends the network by introducing neuron B3 as an additional processing layer in the network, which processes inputs from neurons A2 and B2. Outputs from neurons A2 and B2 are scaled by respective weights (wₐ₂, w_{b2}) along with the overall node weight for B3 (w_{Ob3}) are combined and fed into a summation point. The resulting sum is processed by neuron B3 to generate its output B30. Feedback mechanisms can store and or dynamically adjust the all weights or selective weights dynamically to maintain efficient signal flow and support continuous learning across the layers

FIG. 4G illustrates the final processing stage at neuron C4. Outputs from neurons A3 and B3 are combined and processed by C4, with weights dynamically adjusted for optimal performance. The result is passed through an activation function f(a), which transforms the processed signals into the final network output, ready for interpretation or further application.

FIG. 4H illustrates the overall network architecture, detailing feedback loops from each layer to corresponding Kalman filter sub-algorithms. These sub-algorithms enhance individual layer performance by dynamically adjusting weights and biases. The central Kalman filter may supervise the network, such as by coordinating adjustments across layers to reduce or minimize prediction error and enhance adaptability.

The use of Kalman filters allows for precise noise reduction and real-time optimization, making this architecture suitable for dynamic environments. The feedback system facilitates continuous learning, allowing the network to adapt to new data patterns efficiently. The modular structure supports flexible scaling, allowing the addition or removal of hidden layers and neurons based on the complexity of tasks or the requirements of the edge computing ecosystem. The design also incorporates mechanisms to address vanishing gradients by maintaining constant states in select hidden nodes for a stable learning processes.

The feedback mechanisms illustrated PHIL in FIG. 4H, can dynamically adjust the weights to refine the outputs and align them with the desired results to improve the network's overall processing accuracy. Alternatively, the proposed weight adjustments made my PHIL can be partially implemented, fully implemented or not implemented based on the desired objective. The updated weights from PHIL can be provided to a new or existing model for enhanced training. The output of PHIL can be a flat file or any format representing the weights and or covariant matrix values for each layer and or node allowing for an optimized approach to training models.

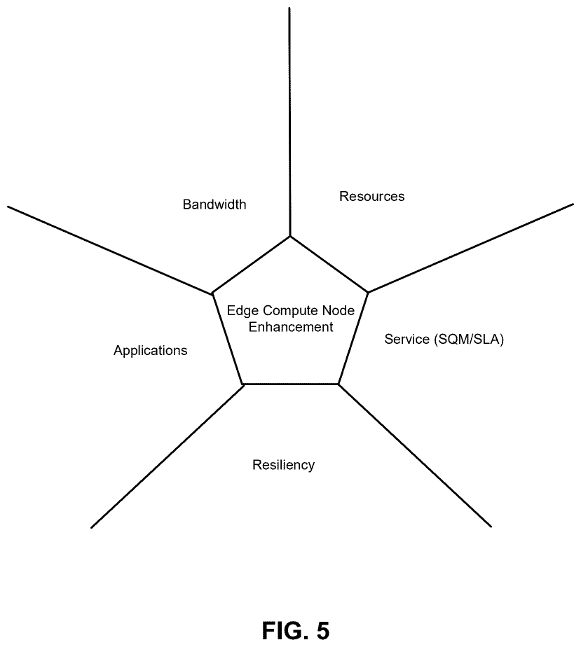

FIG. 5 is a component block diagram illustrating the key factors involved in edge compute node optimization, in accordance with some embodiments. The diagram is structured as a star, with each ray representing a critical component contributing to the overall efficiency and performance of edge computing. The components include Bandwidth, Resources, Service (SQM/SLA), Resiliency, and Applications. The CNN for edge computing has optimization at the center as shown in FIG. 5. The use of subdomains is meant to help classify the various inputs into common groups or classifications. From the classification process DNN may be used to achieve the desired optimization for the network and service delivery.

As discussed above, edge computing represents a paradigm shift toward decentralizing computing tasks to the network's edge, enhancing direct interactions between devices and local computing resources. This shift aims to reduce latency, increase throughput, and enhance security through localized data processing. It also diminishes dependence on traditional cloud-based systems by leveraging edge nodes equipped to operate as middleware for improved performance and security. These nodes may function independently or collaboratively to provide a versatile ecosystem that supports both wired and wireless communications. Consequently, applications may be deployed closer to data sources to improve response times and processing efficiency.

The various embodiments include edge computing systems configured to implement effective management and configuration strategies to sustain performance and address challenges such as limited processing power, memory, and energy resources. The inherent complexities of edge environments often result in manual and error-prone configuration efforts. To mitigate these issues, some embodiments may use AI and neural networks to automate configuration and resource management, thereby realizing “elastic edge computing” for enhanced system flexibility and network responsiveness. Some embodiments may use AI to improve decision-making and/or to adapt algorithms based on input data for continuous system evolution, accuracy, and efficiency. For example, some embodiments may use Kalman filters to fine-tune neural network weight adjustments and achieve more accurate control over learning processes.

Some embodiments may incorporate specialized hardware such as NPUs that boost AI computations within edge networks. These NPUs, whether standalone or integrated with cloud services, may be used to provide scalable solutions for edge applications.

Some embodiments may expand the role of AI in edge computing beyond conventional machine learning techniques to allow the system to adjust to dynamic network topologies and make real-time adaptations without relying on predefined policies. This adaptability may significantly improve the edge computing system's performance and functionality by allowing it to adeptly manage and respond to the evolving demands of the system or network.

Some embodiments may include a system configured for network configuration using neural networks and Kalman filters. The system may include edge computing nodes, neural network processing units (NNPU), a Kalman Filter component, a data collection and preprocessing component, an inference result database (stores inference results from previous network configurations and scenarios), a service vector training component, and a dynamic configuration and management interface. The data collection and preprocessing component gathers and prepares real-time network data, the NNPU runs the CNN models using the processed data to generate enhanced network configurations, and the Kalman filter refines the CNN output for increased accuracy. The edge computing nodes may dynamically apply the refined network configurations, collect feedback on the applied configurations, analyze the collected feedback, and update the CNN models and/or Kalman filter parameters based on the results of the analysis.

Some embodiments may include methods for network configuration using neural networks and Kalman filters. In some embodiments the methods may include using a neural network to enhance and configure a network based on services, inputs, and rules, feeding the output of the neural network into a Kalman filter to adjust the weights and reduce the errors, and reusing inference results from similar networks to speed up the learning process.

Some embodiments may be particularly well suited for edge computing environments in which data processing and analysis occur closer to the data source or edge of the network. This proximity allows for more responsive and agile network management.

Some embodiments may use service vectors representing various network services and their characteristics as a training module to provide a starting point for the neural network. These service vectors may provide a foundational dataset that helps to initialize the neural network and give it a preliminary understanding of the network's operational context and the services it needs to manage.

Some embodiments may allow for multi-WAN connections in a network with different node sizes and capabilities. Some embodiments may dynamically reconfigure the network based on outages, new services, or user demands.

Some embodiments may include a computer-implemented method for managing an edge computing network. In some embodiments, the method may include identifying and classifying a plurality of edge nodes based on capabilities, location, and available resources to establish a categorized node grouping.

In some embodiments, the method may include deploying pre-trained AI models onto the categorized node grouping. In some embodiments, the deployed AI models may be compatible with hardware specifications of Neural Processing Units (NPUs) or software specifications of NPU-lite configurations present within the edge nodes.

In some embodiments, the method may include collecting data on network status, resource availability, and application demands associated with the categorized node grouping.

In some embodiments, the method may include dynamically adjusting configurations and resource allocations of the categorized node grouping based on the collected data using the deployed AI models to enhance performance metrics including but not limited to latency and throughput.

In some embodiments, the method may include implementing continuous learning mechanisms within the deployed AI models to adapt to new data and changing conditions autonomously. In some embodiments, the method may include periodically updating the AI models with incremental adjustments to weights and biases to minimize impacts on bandwidth and latency.

In some embodiments, the method may include facilitating communication among the categorized node grouping to share resources, data, and application capabilities efficiently. In some embodiments, the method may include using AI-driven protocols for collective decision-making on data processing and task distribution.

In some embodiments, the method may include using the deployed AI models to monitor network traffic and behavior within the categorized node grouping. In some embodiments, the method may include identifying and mitigating potential security threats to ensure data privacy and integrity.

In some embodiments, the method may include continuously monitoring the performance of the categorized node grouping and the overall edge computing network using the deployed AI models. In some embodiments, the method may include adjusting operational parameters and configurations in real-time to maintain optimal performance.

In some embodiments, the method may include detecting and responding to changes in the edge computing ecosystem affecting the categorized node grouping, such as the addition or removal of edge nodes, changes in backhaul connectivity, and variations in upstream network resources. In some embodiments, the method may include reconfiguring the network and redistributing workloads.

In some embodiments, the method may include applying neural network models, (e.g., CNNs, DNNs, etc.), for real-time data processing and decision-making at the edge nodes within the categorized node grouping.

In some embodiments, the method may include using inference results of deployed AI models to derive actionable insights from data processed by the edge nodes and support applications requiring immediate response.

In some embodiments, the method may include implementing feedback loops to gather performance data and user feedback. In some embodiments, the method may include refining the deployed AI models and system configurations based on the feedback for continuous improvement of the edge computing network's efficiency and effectiveness.

Some embodiments may include a computer-implemented method for enhancing a Deep Neural Network (DNN) using a Kalman filter and PHIL for dynamic learning and adaptation. In some embodiments, the method may include determining a DNN architecture of the DNN (which may include initializing at least two input nodes, two layers of hidden nodes, and one output node within a computing system) and initializing a Kalman covariant matrix to set initial weights and biases for each node and layer within the DNN based on the determined DNN architecture.

In some embodiments, the method may further include receiving and preprocessing input vectors to fit model requirements (including normalization, encoding, etc.). In some embodiments, the preprocessing may be directly linked to the initialized Kalman covariant matrix.

In some embodiments, the method may further include updating state estimates for each new set of input vectors (e.g., based on the preprocessed input vectors, etc.) by applying a Kalman filter that combines new measurements with predictions from previous measurements to adjust weights and biases of each node and layer in the DNN.

In some embodiments, the method may further include feeding the processed input vectors through the DNN using the adjusted weights and biases, applying the PHIL inference to incorporate both positive and negative reinforcement signals based on performance feedback (the feeding may be a direct consequence of the updating state estimates), and evaluating the output of the DNN against desired results to measure accuracy and effectiveness.

In some embodiments, the method may further include using feedback to apply further adjustments to the DNN parameters through the Kalman filter. In some embodiments, the adjustments may be focused on improvement areas identified during evaluation directly following the feeding process.

In some embodiments, the method may further include dynamically adjusting the DNN architecture by adding or removing hidden layers or nodes based on the evaluation (i.e., to improve the network performance, computation efficiency, etc.). In some embodiments, the dynamic adjustment may be based on the outcomes of the evaluation.

In some embodiments, the method may further include incorporating continuous learning mechanisms to allow the DNN to adapt to new data patterns and changes over time without manual intervention, including periodically updating the DNN model with new weights and biases as determined by ongoing Kalman filter adjustments and the PHIL.

In some embodiments, the method may further include converting complex data inputs into vectorized forms for easier processing and pattern recognition by the DNN.

In some embodiments, the method may further include using vector embeddings to enhance information retrieval and decision-making processes (e.g., which may be directly linked to the continuous learning mechanisms).

In some embodiments, the method may further include monitoring and enhancing the inference performance of the DNN to maintain required levels of accuracy while minimizing latency.

In some embodiments, the method may further include ensuring the DNN is optimally located within the computing system architecture to facilitate quick data processing and interaction with the solution domain.

In some embodiments, the method may further include enabling the DNN to dynamically learn and adapt using the Kalman filter and PHIL, enhancing its performance for various applications and/or ensuring high accuracy and minimal latency in real-time decision-making processes.

As mentioned above, some embodiments may include a system configured for network configuration using neural networks and Kalman filters. The system may include edge computing nodes, NNPU, a Kalman Filter component, a data collection and preprocessing component, an inference result database, a service vector training component, and a dynamic configuration and management interface. The data collection and preprocessing component gathers and prepares real-time network data, the NNPU runs the CNN models use the processed data to generate enhanced network configurations, and the Kalman filter refines the CNN output for increased accuracy.

The edge computing nodes may dynamically apply the refined network configurations, collect feedback on the applied configurations, analyze the collected feedback, and update the CNN models and/or Kalman filter parameters based on the results of the analysis.

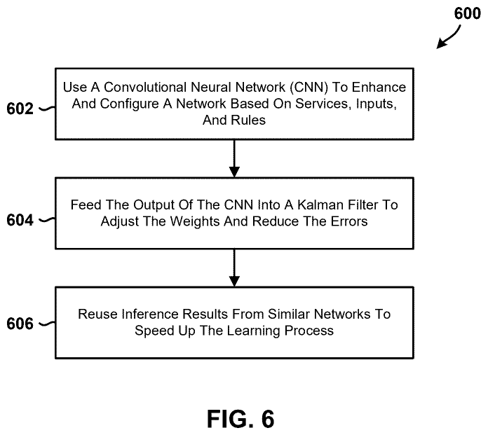

FIG. 6 is a process flow diagram illustrating a method 600 for network configuration using neural networks and Kalman filters in accordance with some embodiments.

In block 602, the processing system may use a CNN to enhance and configure a network based on services, inputs, and rules. For example, the processing system may initialize a CNN with multiple convolutional layers designed to extract hierarchical features from network telemetry data, such as traffic flow patterns, bandwidth usage, and latency metrics. Each convolutional layer may apply a kernel function to compute weighted sums across different spatial regions of the input data, allowing the network to detect patterns in network performance that correlate with specific configurations. The CNN may then generate an improved set of network parameters, including routing decisions, bandwidth allocation strategies, and access control policies.

In block 604, the processing system may feed the output of the CNN into a Kalman filter to adjust the weights and reduce the errors. For example, the processing system may use the Kalman filter to refine the CNN-generated network configurations by incorporating uncertainty estimates derived from network fluctuations. The Kalman filter may iteratively update predictions for optimal network settings by integrating historical data with real-time feedback from monitoring sensors, reducing overfitting to transient conditions. The filter may compute an error covariance matrix and dynamically adjust weight values in the CNN so that network settings remain optimal under varying conditions. The processing system may store the update predictions and update the local model allowing for the updated predictions to be used as an input to a transfer learning process while keeping the local model unaltered.

In block 606, the processing system may reuse inference results from similar networks to speed up the learning process. For example, the processing system may store and retrieve previous CNN and Kalman filter outputs from similar network environments and apply a transfer learning approach to accelerate convergence. If a newly deployed network shares structural similarities with a previously enhanced network (e.g., identical topology, similar traffic patterns), the processing system may initialize the new network's configuration using stored inference results to reduce the time required for network adaptation and optimization. In an existing system updates to the model may be implemented on selective node(s) and or layer(s).

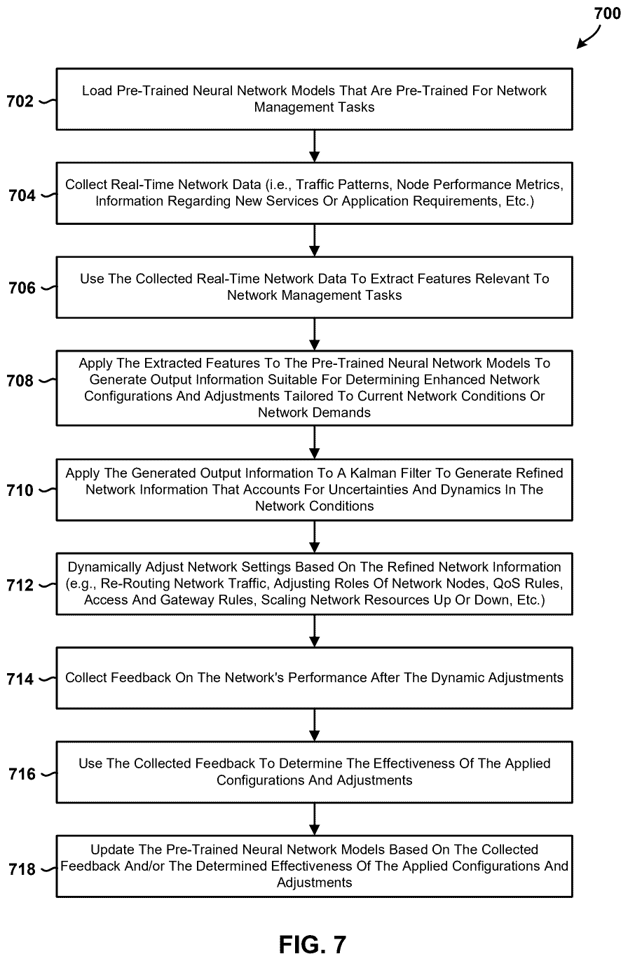

FIG. 7 is a process flow diagram illustrating a method 700 for dynamic network management in a computing device in accordance with some embodiments. The pre-trained model could be applied to selective node(s) or layer(s) in an optimized method of updating the model. (my software path concept)

In block 702, the processing system may load pre-trained neural network models that are pre-trained for network management tasks. For example, the processing system may select and load a neural network model trained on historical network data. This data may include labeled datasets containing performance metrics and configuration decisions. Pre-trained models may include RNNs for analyzing time-series data or transformer-based models for identifying long-range dependencies in network behavior.

In block 704, the processing system may collect real-time network data (i.e., traffic patterns, node performance metrics, information regarding new services or application requirements, etc.). For example, the processing system may establish a data ingestion pipeline that continuously gathers telemetry data from edge nodes, routers, and network controllers. The collected data may undergo statistical preprocessing, such as mean centering and standardization, to achieve consistency for subsequent feature extraction.

In block 706, the processing system may use the collected real-time network data to extract features relevant to network management tasks. For example, the processing system may apply principal component analysis (PCA) to reduce dimensionality while preserving variance in network telemetry data. Clustering techniques, such as k-means or Gaussian mixture models, may categorize network traffic patterns into states such as high-load, medium-load, and low-load.

In block 708, the processing system may apply the extracted features to the pre-trained neural network models to generate output information suitable for determining enhanced network configurations and adjustments tailored to current network conditions or network demands. For example, the processing system may process the features through a deep learning model trained to classify network conditions and suggest optimizations. The output layer of the model may produce probability distributions for possible network adjustments, such as rerouting traffic, prioritizing latency-sensitive applications, or modifying Quality of Service (QOS) policies.

In block 710, the processing system may apply the generated output information to a Kalman filter to generate refined network information that accounts for uncertainties and dynamics in the network conditions. That is, the processing system may refine the output information using a Kalman filter to account for uncertainties and dynamic network conditions. For example, the Kalman filter may incorporate real-time feedback from network performance data to refine predictions. Through a prediction-correction cycle, the Kalman filter may adjust prior estimates based on observed deviations from expected behavior. The system may iteratively update the Kalman gain to emphasize reliable measurements while reducing the impact of noisy or inconsistent inputs.

In block 712, the processing system may dynamically adjust network settings based on the refined network information (e.g., re-routing network traffic, adjusting roles of network nodes, scaling network resources up or down, etc.). That is, the processing system may apply refined network information to dynamically adjust network settings. For example, the system may reroute data traffic by updating routing tables to balance loads, promote lower-latency paths, or reduce congestion. The processing system may also modify operational roles of network nodes by transitioning specific nodes between active and standby states based on predicted utilization levels. The processing system may also modify access and gateway rules. Resource scaling may include adjusting bandwidth allocations, activating additional computing instances, or modifying Quality of Service (QOS) rules to address projected demand.

In block 714, the processing system may collect feedback on the network performance following dynamic adjustments. For example, the system may retrieve metrics such as packet loss rates, average latency, jitter levels, and throughput stability from network sensors. The collected data may be logged and analyzed to evaluate the impact of configuration changes on network efficiency and to identify potential bottlenecks.

In block 716, the processing system may use the collected feedback to determine the effectiveness of the applied configurations and adjustments. For example, the system may compare network performance before and after adjustments by calculating performance deltas and applying statistical tests, such as t-tests or variance analysis, to verify measurable improvements. Machine learning classifiers trained on historical network events may predict whether the applied adjustments align with optimal operating conditions.

In block 718, the processing system may update the pre-trained neural network models based on the collected feedback and/or the determined effectiveness of the applied configurations and adjustments. For example, the processing system may refine the neural network models by incorporating post-adjustment feedback into a continuous training pipeline. The neural network weights may be updated incrementally using an adaptive learning rate to prevent abrupt parameter shifts that could destabilize model predictions. In addition, the processing system may apply reinforcement learning techniques in which successful network configurations are assigned to higher reward values to allow the model to prioritize similar adjustments in future decision-making cycles.

In some embodiments, the processing system may be further configured to detect and integrate new software updates, enhancements, and requirements for new services or applications into the neural network models' training data. In some embodiments, the processing system may be further configured to monitor the network for issues or anomalies and use anomaly detection algorithms to monitor the network health and reliability of the post-configuration adjustments. In some embodiments, the processing system may be further configured to adjust the neural network model and Kalman filter parameters based on the result of periodically re-evaluating the network management strategy against current network performance metrics and external conditions.

In some embodiments, adjusting the neural network model and the Kalman filter parameters based on the result of periodically re-evaluating the network management strategy against current network performance metrics and external conditions may include adjusting the noise covariance matrices (process noise covariance, measurement noise covariance, etc.) of the Kalman filter, altering the neural network's learning rate to enhance the speed and accuracy of convergence towards enhanced network configurations, and/or modifying the number of layers and/or the number of nodes within each layer of the neural network.

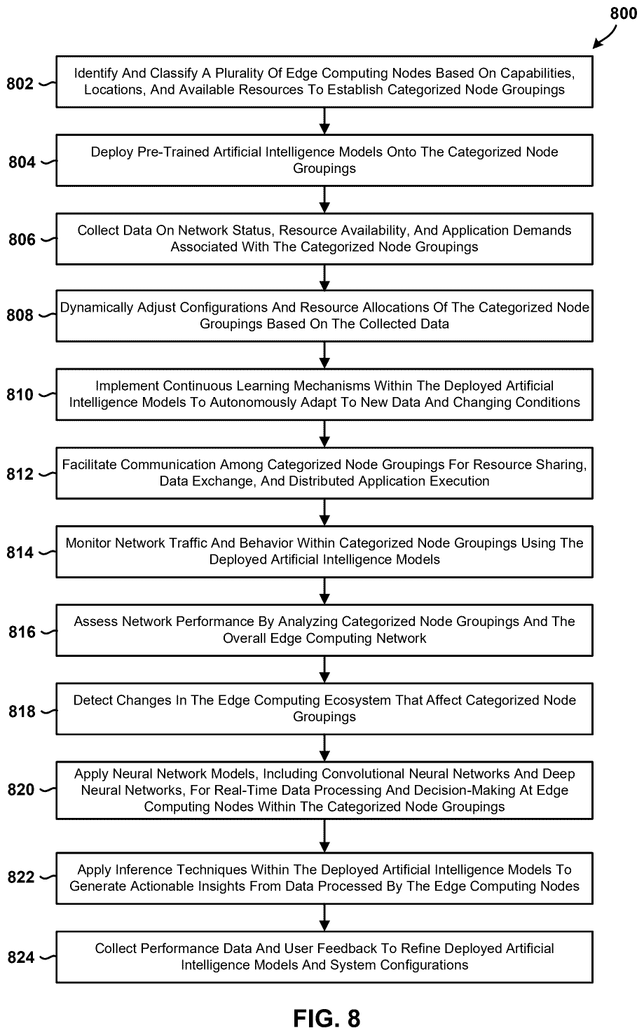

FIG. 8 is a process flow diagram illustrating a method 800 for managing an edge computing network in accordance with some embodiments. The processing system may execute the method 800 to classify edge computing nodes, deploy AI models, allocate resources, and adjust network configurations based on real-time data.

In block 802, the processing system may identify and classify edge computing nodes based on capabilities, locations, and available resources. The processing system may retrieve metadata from edge computing nodes, including hardware specifications such as CPU architecture and memory capacity, and connectivity attributes such as backhaul link availability and proximity to data centers. The processing system may apply a hierarchical clustering algorithm to assign nodes into functional categories, such as compute-intensive nodes, storage-focused nodes, and low-latency gateway nodes. The processing system may refine classifications dynamically by evaluating real-time telemetry data and historical performance trends.

In block 804, the processing system may deploy pre-trained AI models to categorized node groupings. The processing system may determine compatibility with neural processing units or software-based inference configurations, such as NPU-lite environments. The processing system may distribute full-scale models to nodes with dedicated neural processing units and may deploy inference-optimized models to resource-constrained nodes. The processing system may convert models into edge-compatible formats, apply quantization techniques to reduce model size, and partition models across multiple nodes for distributed execution.

In block 806, the processing system may collect network status data, resource availability metrics, and application demand data from categorized node groupings. The processing system may establish secure pipelines to aggregate telemetry data from edge nodes, including processor utilization, memory availability, energy consumption, latency metrics, and network throughput. The processing system may apply adaptive sampling techniques to reduce data transmission overhead by prioritizing high-impact data for frequent collection and periodically sampling lower-priority data.

In block 808, the processing system may dynamically adjust configurations and resource allocations for categorized node groupings. The processing system may analyze the collected data and optimize performance metrics such as latency and throughput. The processing system may allocate workloads to nodes based on real-time resource availability. If a node reaches a predefined utilization threshold, the processing system may offload a portion of the workload to a node with lower utilization. The processing system may adjust bandwidth allocations, modify caching strategies, and prioritize network traffic for latency-sensitive applications.

In block 810, the processing system may implement continuous learning mechanisms to adapt deployed AI models to changing conditions. The processing system may periodically update model parameters, including weights and biases, while minimizing bandwidth usage and latency. The processing system may apply federated learning to update models across distributed edge nodes without aggregating raw data centrally. The processing system may aggregate model weight updates from multiple nodes, apply differential privacy techniques to protect data integrity, and refine global models before redistributing updates. The processing system may apply reinforcement learning techniques to adjust model hyperparameters based on observed performance trends.

In block 812, the processing system may facilitate communication among categorized node groupings for resource sharing, data exchange, and distributed application execution. The processing system may establish an adaptive communication framework that allows edge nodes to form peer-to-peer connections based on workload dependencies. The processing system may analyze resource availability across nodes and advertise surplus processing capacity while allowing other nodes to request assistance as demand arises. The processing system may apply predictive analytics to anticipate workload surges and redistribute resources before performance degradation occurs.

In block 814, the processing system may monitor network traffic and behavior within categorized node groupings using the deployed AI models. The processing system may identify potential security threats and apply mitigation measures to maintain data privacy and integrity. The processing system may execute anomaly detection algorithms to identify deviations from normal network behavior. The processing system may use autoencoders or clustering-based methods to detect previously unseen attack patterns. Upon detecting a threat, the processing system may modify firewall policies, isolate affected nodes, or enforce stricter authentication protocols.

In block 816, the processing system may assess network performance by analyzing categorized node groupings and the overall edge computing network. The processing system may analyze key performance indicators such as congestion levels, response times, and energy consumption. The processing system may apply predictive modeling techniques to forecast network demand and determine corrective actions. If the processing system detects performance degradation, it may redistribute workloads, modify memory allocations, or increase caching update frequencies.

In block 818, the processing system may detect changes in the edge computing ecosystem that affect categorized node groupings. The processing system may detect changes such as the addition or removal of nodes, variations in backhaul connectivity, or updates to upstream network resources. The processing system may restructure the network topology in response to detected changes. If a node goes offline, the processing system may reroute traffic through alternative paths. If new nodes become available, the processing system may integrate them by redistributing workloads and synchronizing relevant data.

In block 820, the processing system may apply neural network models, including convolutional neural networks and deep neural networks, for real-time data processing and decision-making at edge nodes. The processing system may execute convolutional neural networks to analyze image or video data and recurrent neural networks to identify temporal patterns in network activity. The processing system may use hybrid models that combine multiple architectures to improve inference accuracy across multimodal datasets.

In block 822, the processing system may apply inference techniques to generate actionable insights from data processed at edge nodes. The processing system may use attention-based mechanisms to prioritize inference tasks. For example, in industrial IoT deployments, the processing system may prioritize safety-critical sensor readings over routine diagnostics. The processing system may implement real-time feedback loops to refine inference models based on evolving operational conditions.

In block 824, the processing system may collect performance data and user feedback to refine deployed AI models and system configurations. The processing system may apply an adaptive learning framework to update models incrementally. If the processing system determines that a configuration yields suboptimal results, it may adjust model parameters, refine feature selection criteria, or introduce additional training samples. The processing system may also integrate user-driven performance evaluations to supplement automated processes and provide network administrators with oversight when necessary.

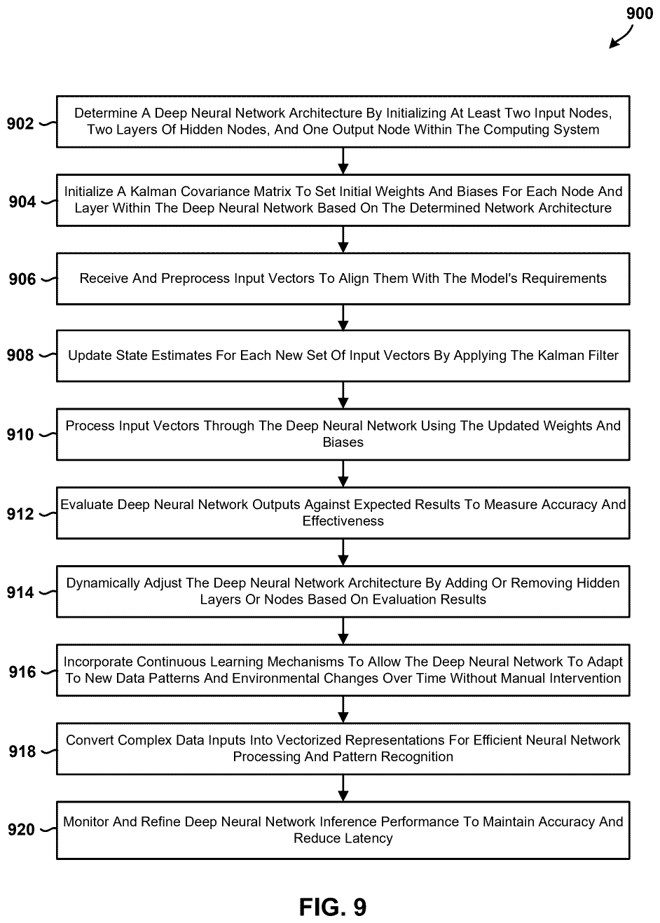

FIG. 9 is a process flow diagram illustrating a method 900 for enhancing a deep neural network using a Kalman filter and PHIL for dynamic learning and adaptation in accordance with some embodiments. The processing system may execute the method to refine neural network parameters, optimize inference performance, and incorporate continuous learning mechanisms.

In block 902, the processing system may determine a deep neural network architecture by initializing at least two input nodes, two layers of hidden nodes, and one output node within the computing system. For example, the processing system may define an architecture with fully connected layers, where each hidden layer applies an activation function such as ReLU or sigmoid to introduce non-linearity. The processing system may configure the input layer to receive raw sensor data and the output layer to generate classification or regression results. The processing system may select the number of hidden nodes per layer based on task complexity and apply a weight initialization strategy to improve convergence stability. The number of hidden nodes per layer may be adjusted dynamically based on the task complexity.

In block 904, the processing system may initialize a Kalman covariance matrix to set initial weights and biases for each node and layer within the deep neural network based on the determined network architecture. For example, the processing system may compute an initial error covariance matrix based on training dataset variance and may apply an adaptive initialization scheme that scales variance dynamically according to model complexity. The processing system may store uncertainty estimates within the Kalman covariance matrix, allowing the system to regulate weight updates by balancing exploration and exploitation. The processing system may approximate an inverse Hessian matrix to stabilize covariance values when processing high-dimensional input data.

In block 906, the processing system may receive and preprocess input vectors to align them with the model's requirements. For example, the processing system may normalize input vectors using min-max scaling or z-score normalization to maintain consistency across distributions. The processing system may store the preprocessed data in a high-throughput buffer for real-time inference. The processing system may apply principal component analysis (PCA) or t-distributed stochastic neighbor embedding (t-SNE) to reduce input dimensionality while retaining key features. The processing system may encode categorical variables using one-hot encoding for compatibility with the deep neural network architecture.

In block 908, the processing system may update state estimates for each new set of input vectors by applying the Kalman filter. The processing system may integrate new measurements with predictions from prior measurements to refine weight and bias values throughout the network. For example, the processing system may execute Kalman update equations and compute the Kalman gain to minimize expected error variance. The processing system may propagate updated weight estimates through the neural network to improve convergence. If the processing system detects non-linear transformations within the network, it may apply an extended Kalman filter (EKF) to update state estimates in a non-linear framework. If the processing system processes highly complex datasets, it may apply an unscented Kalman filter (UKF) to improve weight estimation accuracy.

In block 910, the processing system may process input vectors through the deep neural network using the updated weights and biases. The processing system may apply the PHIL inference method to incorporate positive and negative reinforcement signals based on performance feedback. For example, the processing system may propagate updated vectors through each neural network layer and apply batch normalization at intermediate layers to stabilize gradient updates. The processing system may dynamically adjust reinforcement weights within the PHIL inference method based on task relevance, prioritizing updates in environments with rapidly changing conditions. The processing system may apply dropout regularization to mitigate overfitting while preserving model generalizability.

In block 912, the processing system may evaluate deep neural network outputs against expected results to measure accuracy and effectiveness. Based on the evaluation, the processing system may adjust neural network parameters through the Kalman filter to refine performance. For example, the processing system may compare inference results to labeled ground-truth data using evaluation metrics such as mean squared error (MSE) for regression tasks or cross-entropy loss for classification tasks. The processing system may apply an adaptive learning rate schedule to regulate the rate of weight updates in response to observed accuracy trends. If performance declines, the processing system may fine-tune hyperparameters, adjust network depth, or modify regularization coefficients.

In block 914, the processing system may dynamically adjust the deep neural network architecture by adding or removing hidden layers or nodes based on evaluation results. The processing system may analyze neuron activation patterns to identify underutilized layers or nodes. If a layer contributes minimally to overall accuracy, the processing system may prune it to improve efficiency. If performance plateaus, the processing system may expand network depth by adding hidden layers to increase feature extraction capacity. The processing system may also modify kernel sizes in convolutional layers to accommodate tasks with varying receptive field requirements.

In block 916, the processing system may incorporate continuous learning mechanisms to allow the deep neural network to adapt to new data patterns and environmental changes over time without manual intervention. The processing system may update model weights and biases periodically using Kalman filter refinements and PHIL-based adjustments. For example, the processing system may implement an online learning framework that incrementally updates network parameters without requiring full model retraining. The processing system may apply meta-learning techniques to refine learning strategies, improving adaptation speed for new data distributions. The processing system may regulate updates based on uncertainty thresholds to accelerate adaptation in dynamic conditions while stabilizing parameters in stable environments.

In block 918, the processing system may convert complex data inputs into vectorized representations for efficient neural network processing and pattern recognition. The processing system may apply vector embeddings to enhance information retrieval and decision-making. For example, the processing system may apply word embeddings when processing natural language data to transform text into high-dimensional vector representations that capture semantic relationships. In image-processing applications, the processing system may extract features before vectorizing image content for neural network input. The processing system may store vectorized data in a low-latency indexed structure to accelerate retrieval operations.

In block 920, the processing system may monitor and refine deep neural network inference performance to maintain accuracy while minimizing latency. The processing system may position the deep neural network within the computing architecture to support efficient data processing and interaction with downstream applications. For example, the processing system may dynamically allocate inference workloads between cloud-based resources and edge devices based on network conditions. If low-latency responses are required, the processing system may offload inference operations to specialized accelerators such as field-programmable gate arrays (FPGAs) or tensor processing units (TPUs). The processing system may apply model quantization techniques to compress network parameters and reduce memory usage while maintaining acceptable accuracy. The processing system may implement a real-time scheduler to prioritize high-importance inference tasks over background computations, improving resource allocation efficiency.

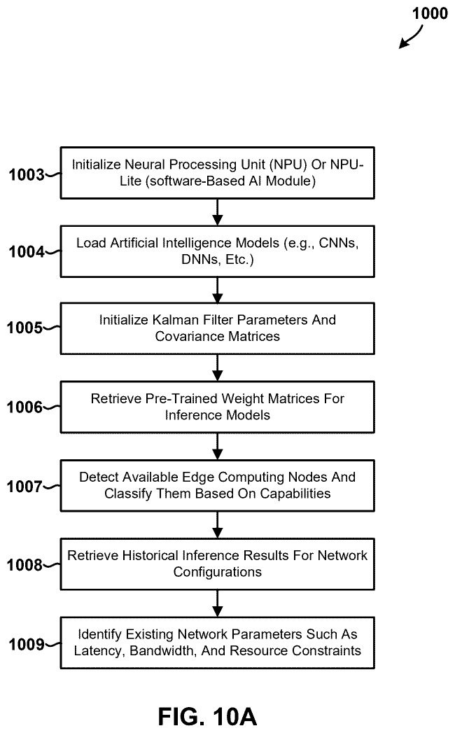

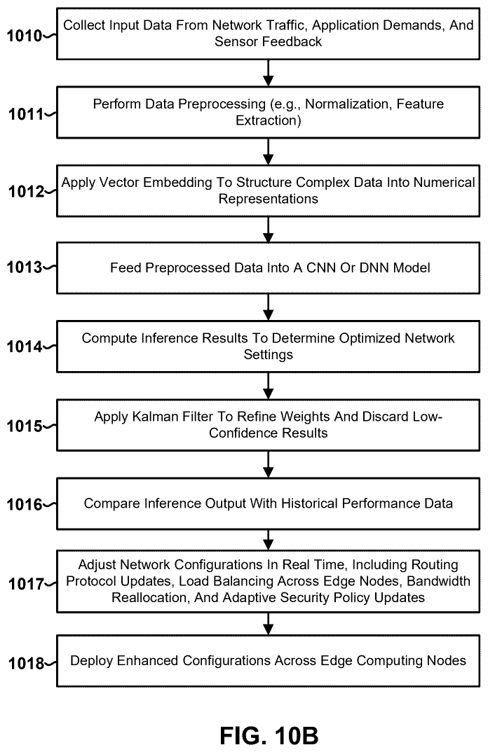

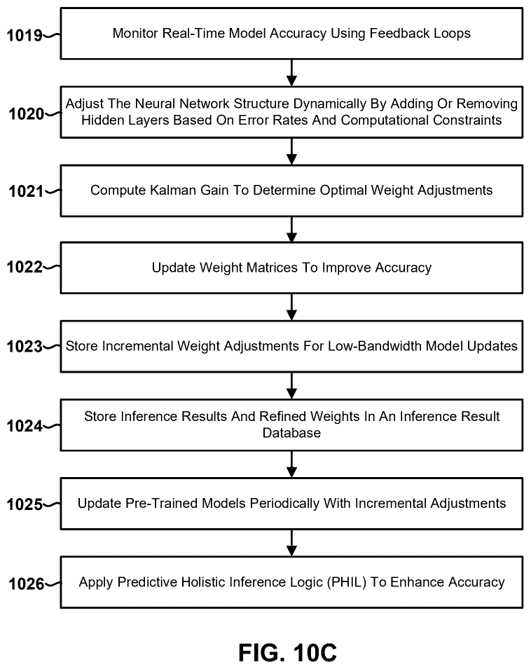

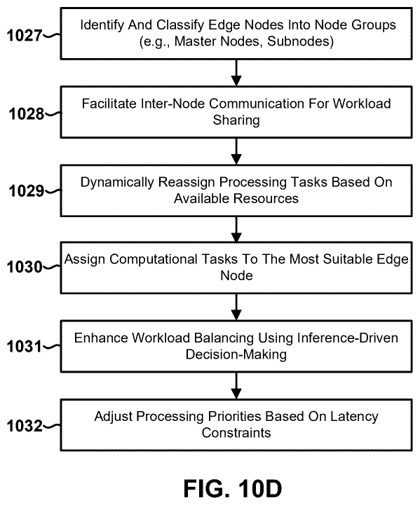

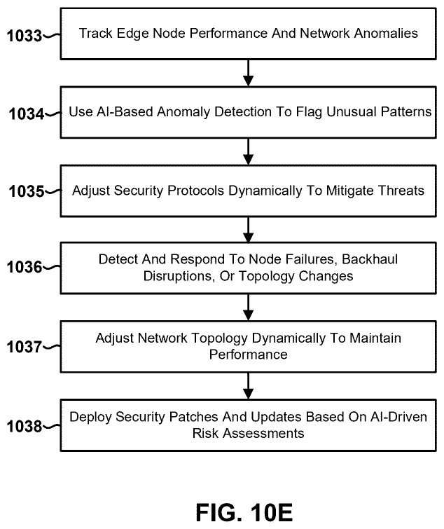

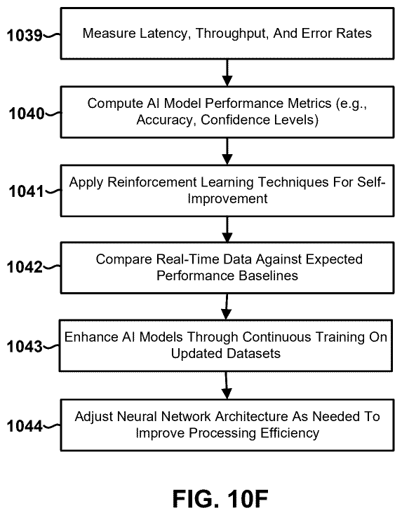

FIGS. 10A-10F are process flow diagrams illustrating a method 1000 for AI-driven adaptive edge computing in accordance with some embodiments. The processing system may execute the method to initialize AI modules, configure inference models, and manage network optimizations based on real-time conditions.

In block 1003, the processing system may initialize a NPU or an NPU-lite software-based AI module. For example, the processing system may configure AI acceleration hardware, allocate memory for deep learning computations, and verify compatibility with pre-loaded AI models. The processing system may determine computational limits and modify processing pipelines to balance inference speed and accuracy.

In some embodiments, the processing system may initialize an AI runtime environment by loading required drivers and allocating dedicated memory regions for tensor computations. If an NPU is present, the processing system may verify the availability of instruction set optimizations such as tensor-based acceleration or low-power inference modes. If an NPU is not available, the processing system may default to a software-based AI module that applies single instruction, multiple data (SIMD) operations for neural network execution.

In block 1004, the processing system may load AI models, including CNNs and DNNs. For example, the processing system may retrieve model parameters from onboard storage or a remote server and apply model compression techniques such as pruning or quantization to optimize memory usage. The processing system may validate model integrity and perform compatibility checks before deploying the models across edge devices.

In some embodiments, the processing system may be configured to load AI models in ONNX format and convert them into an enhanced representation using TensorRT. The processing system may validate the model by checking layer dependencies to confirm the presence of required activation functions and executing an initial inference test on sample input data to verify accuracy before deployment.

In block 1005, the processing system may initialize Kalman filter parameters and covariance matrices. For example, the processing system may configure the Kalman filter to refine weight updates in neural network layers by filtering noise from input data. The processing system may compute initial covariance values based on historical variance metrics and adjust error thresholds dynamically to improve inference convergence.

In some embodiments, the processing system may initialize state transition matrices and observation models to structure how weight updates are predicted and refined. The processing system may assign initial variance values based on training dataset statistics and apply a recursive update mechanism to refine covariance estimates over time.

In block 1006, the processing system may retrieve pre-trained weight matrices for inference models. For example, the processing system may select weight parameters optimized for edge-based execution, reducing latency without requiring full model retraining. The processing system may apply transfer learning techniques to adapt the weight parameters to the edge computing environment.

In some embodiments, the processing system may fetch model weights stored in FP16 or INT8 format to balance precision and computational efficiency. If the pre-trained weights originate from a cloud-trained model, the processing system may adjust them using fine-tuning techniques, such as stochastic gradient descent, to align them with real-world edge deployment scenarios.

In block 1007, the processing system may detect available edge computing nodes and classify them based on capabilities. For example, the processing system may assess each node's processing power, memory capacity, and network connectivity. The processing system may organize nodes into functional categories, including high-performance computing nodes, storage nodes, and low-latency gateway nodes.

In some embodiments, the processing system may execute a distributed service discovery protocol, such as multicast DNS (mDNS) or gRPC-based node registration, to identify and classify edge nodes. The processing system may measure floating-point operations per second (FLOPS) and available network bandwidth to classify nodes into performance-based tiers.

In block 1008, the processing system may retrieve historical inference results for network configurations. For example, the processing system may analyze previous network optimizations to identify effective configurations for similar conditions. The processing system may apply this data to refine AI-driven decision-making and reduce adaptation time when adjusting network parameters.

In some embodiments, the processing system may maintain an indexed database of past inference outcomes, storing data such as optimal routing tables, past load-balancing decisions, and observed latencies under various conditions. The processing system may apply a weighted averaging technique to prioritize recent successful configurations over older settings.

In block 1009, the processing system may identify network parameters such as latency, bandwidth availability, and resource constraints. For example, the processing system may continuously monitor network conditions and update real-time statistics to improve data routing and workload distribution. The processing system may use these collected parameters as input for AI-based network optimizations.

In some embodiments, the processing system may poll network statistics using Simple Network Management Protocol (SNMP) or direct TCP socket measurements. The processing system may apply exponential smoothing to filter transient fluctuations and maintain a stable estimate of network conditions for AI-driven decision-making.

With reference to FIG. 10B, in block 1010, the processing system may collect input data from network traffic, application demands, and sensor feedback. For example, the processing system may retrieve data related to packet transmission rates, device utilization metrics, and environmental sensor readings. The processing system may aggregate the collected data and apply preprocessing operations before performing AI-driven analysis.

In some embodiments, the processing system may use Kafka or MQTT brokers to collect and organize data from multiple edge devices. The processing system may implement priority queues to process time-sensitive packets first, allowing critical network conditions to be analyzed with minimal delay.

In block 1011, the processing system may preprocess the collected data by applying normalization and feature extraction techniques. For example, the processing system may scale numerical values to a uniform range and extract key attributes relevant to AI inference. Preprocessing may reduce computational complexity and improve model accuracy.

In some embodiments, the processing system may apply principal component analysis (PCA) to reduce dimensionality while retaining the most influential network parameters. The processing system may remove outliers using a median-based filtering technique before forwarding the preprocessed data to AI models.

In block 1012, the processing system may apply vector embedding to convert complex data into structured numerical representations. For example, the processing system may use vector embeddings to capture semantic relationships between data points, improving the ability of AI models to detect patterns in network behavior.

In some embodiments, the processing system may use cosine similarity calculations to cluster network state representations. The processing system may apply Word2Vec-like models trained on past network states to allow edge nodes to interpret high-level traffic flow structures.

In block 1013, the processing system may process the preprocessed data using a CNN or a deep neural network (DNN). For example, the processing system may analyze traffic patterns, predict congestion points, and recommend configuration adjustments. The processing system may use model ensembles to combine multiple AI architectures to improve inference accuracy.

In some embodiments, the processing system may deploy a hybrid model that integrates CNNs for spatial analysis and RNNs for temporal dependency modeling. The processing system may use this architecture to predict latency spikes based on historical traffic trends.

In block 1014, the processing system may compute inference results to determine optimized network configurations. For example, the processing system may generate recommendations for bandwidth allocation, routing policies, and load distribution. The processing system may assign confidence scores to each recommendation to prioritize highly reliable configurations.

In some embodiments, the processing system may apply Bayesian optimization techniques to refine inference results based on statistical confidence levels. The processing system may integrate reinforcement learning feedback loops to continuously adjust recommendations according to real-time network conditions.

In block 1015, the processing system may apply a Kalman filter to refine weight adjustments and remove low-confidence results. For example, the processing system may update neural network parameters using real-time feedback while suppressing weight changes influenced by noisy or inconsistent data.

In some embodiments, the processing system may execute an extended Kalman filter (EKF) to accommodate nonlinear relationships in network behavior. The processing system may use a covariance adaptation mechanism to adjust error estimates dynamically based on observed inference discrepancies.

In block 1016, the processing system may compare the inference output to historical performance data. For example, the processing system may analyze past network optimizations to determine whether newly proposed configurations align with effective strategies. If the processing system detects discrepancies, it may adjust AI model weighting to prioritize configurations that previously improved network efficiency.

In some embodiments, the processing system may maintain a rolling buffer of past network optimizations in a time-series database. The processing system may compute similarity scores using dynamic time warping (DTW) techniques to compare current network trends with prior conditions and adjust inference weights accordingly.

In block 1017, the processing system may adjust network configurations dynamically based on inference results. For example, the processing system may update routing protocols, balance workloads across edge nodes, reallocate bandwidth, and modify security policies. The processing system may prioritize low-latency applications while optimizing bandwidth utilization.

The processing system may integrate with software-defined networking (SDN) controllers to update routing tables dynamically. The processing system may implement rate-limiting policies on network paths based on Quality of Service (QOS) priority settings.

In block 1018, the processing system may deploy optimized configurations across edge computing nodes. For example, the processing system may apply configuration updates incrementally to reduce service disruptions. The processing system may implement rollback mechanisms to revert changes if performance degradation occurs.

The processing system may use a version-controlled configuration management system to maintain rollback points. The processing system may execute a phased deployment strategy, testing new configurations on a subset of nodes before applying changes to the entire network.

With reference to FIG. 10C, in block 1019, the processing system may monitor real-time model accuracy using feedback loops. For example, the processing system may track model performance metrics by continuously analyzing inference accuracy in response to real-time network conditions. The processing system may compare predicted outputs to actual network behavior to identify deviations from expected performance.

In some embodiments, the processing system may apply weighted moving averages to track long-term accuracy trends. The processing system may trigger recalibration when deviations exceed a predefined threshold. The processing system may adjust accuracy thresholds dynamically based on network variability to prevent unnecessary recalibrations.

In block 1020, the processing system may adjust the neural network structure dynamically by adding or removing hidden layers based on error rates and computational constraints. For example, the processing system may analyze neuron activation patterns to determine whether specific layers contribute to inference accuracy. If a layer consistently exhibits low activation, the processing system may remove it to improve computational efficiency. In some embodiments, the processing system may add a hidden layer in response to determining that the hidden layer would contribute to inference accuracy or would exhibit high activation.

In some embodiments, the processing system may implement a self-pruning mechanism that identifies and removes neurons with low or minimal activation gradients. The processing system may apply adaptive dropout layers to selectively deactivate overfitting nodes. The processing system may replace activation functions with alternatives such as ReLU or Leaky ReLU to optimize learning efficiency.

In block 1021, the processing system may compute the Kalman gain to determine optimal weight adjustments. For example, the processing system may use real-time feedback to refine weight updates and improve convergence rates. The processing system may calculate the Kalman gain by integrating weighted error estimates, allowing high-confidence weight updates to receive priority.

In some embodiments, the processing system may dynamically adjust gain coefficients based on environmental variance. The processing system may apply covariance adaptation techniques to reduce weight fluctuations in stable conditions and accelerate adjustments in dynamic environments.

In block 1022, the processing system may update weight matrices incrementally to improve accuracy. For example, the processing system may apply refined weight updates without requiring full model retraining. The processing system may optimize weight adjustments using delta encoding to store differences between previous and updated weight values.

In some embodiments, the processing system may store weight adjustments as delta values in a compressed format. The processing system may transmit only necessary modifications to distributed edge nodes to reduce bandwidth consumption. The processing system may integrate batch updates to minimize latency when synchronizing weight adjustments across multiple nodes.

In block 1023, the processing system may store incremental weight adjustments for low-bandwidth model updates. For example, the processing system may prioritize sending weight updates to constrained edge devices while maintaining efficient network resource usage. The processing system may implement federated learning techniques to distribute weight differentials instead of full model updates.

In some embodiments, the processing system may aggregate updates from multiple edge nodes before propagating them across the network. The processing system may apply differential privacy techniques to secure weight updates and prevent data leakage.

In block 1024, the processing system may store inference results and refined weights in an inference result database. For example, the processing system may maintain indexed records of past inference computations and weight refinements to accelerate AI-driven optimizations in similar environments.

In some embodiments, the processing system may use NoSQL databases optimized for high-speed retrieval to store inference results. The processing system may organize records based on hardware compatibility and network conditions to facilitate efficient query execution.

In block 1025, the processing system may update pre-trained models periodically using incremental adjustments. For example, the processing system may incorporate newly observed patterns in network traffic and device behavior into the existing model architecture. The processing system may execute asynchronous model updates to prevent disruptions in real-time inference tasks.

In some embodiments, the processing system may apply distributed knowledge distillation techniques to merge updates from multiple edge nodes into a unified model. The processing system may adjust model parameters dynamically based on confidence scores assigned to recent training data.

In block 1026, the processing system may apply PHIL to enhance inference accuracy. For example, the processing system may integrate multiple inference sources to refine model predictions through a consensus-based approach.

In some embodiments, the processing system may apply ensemble learning across different AI models and assign weights to inference results based on historical reliability scores. In some embodiments, the processing system may apply reinforcement learning reward signals to improve decision-making by prioritizing inference strategies that historically produced accurate predictions.

With reference to FIG. 10D, in block 1027, the processing system may identify and classify edge nodes into node groups, including master nodes and subnodes. For example, the processing system may analyze network topology and resource availability to determine the functional roles of edge nodes. The processing system may assign master nodes to manage workload distribution and delegate computational tasks to subnodes based on processing capacity.

In some embodiments, the processing system may execute a leader-election algorithm to dynamically select master nodes. The processing system may evaluate network conditions, node availability, and historical performance data to establish leadership among nodes. The processing system may update node classifications in response to changes in workload demand or resource availability.

In block 1028, the processing system may establish communication between edge nodes to support workload sharing. For example, the processing system may coordinate computational resource exchanges among nodes to distribute processing demands efficiently. The processing system may synchronize data sharing to support distributed AI inference across multiple edge nodes.

In some embodiments, the processing system may implement message-passing interfaces (MPI) or remote procedure call (RPC) protocols to facilitate real-time inter-node communication. The processing system may monitor communication latency and bandwidth usage to optimize data transmission pathways. The processing system may adjust synchronization intervals to balance computational efficiency and network overhead.

In block 1029, the processing system may reassign processing tasks dynamically based on real-time resource availability. For example, the processing system may monitor CPU, GPU, and memory usage metrics to identify underutilized nodes. The processing system may shift workloads to nodes with available resources to prevent bottlenecks and enhance computational efficiency.

In some embodiments, the processing system may apply a reinforcement learning-based load balancer to optimize task allocation. The processing system may analyze historical workload distributions and real-time telemetry data to improve assignment decisions. The processing system may prioritize resource allocation based on task complexity and node-specific performance metrics.

In block 1030, the processing system may assign computational tasks to the most suitable edge node. For example, the processing system may evaluate selection criteria such as processing power, network latency, and energy efficiency. The processing system may determine the optimal execution environment for each task to maintain low-latency processing and resource efficiency.

In some embodiments, the processing system may use a weighted round-robin scheduling mechanism to allocate workloads. The processing system may assign execution priority based on node health, task urgency, and historical performance data. The processing system may adjust task distribution policies dynamically to maintain balanced workload distribution across edge nodes.

In block 1031, the processing system may enhance workload balancing through inference-driven decision-making. For example, the processing system may analyze historical network traffic and processing trends to predict future workload distribution. The processing system may use predictive modeling to adjust resource allocation before congestion occurs.

In some embodiments, the processing system may implement a long short-term memory (LSTM) forecasting model to anticipate workload surges. The processing system may migrate computational tasks proactively to prevent processing delays. The processing system may optimize throughput by dynamically reconfiguring execution priorities based on predicted network conditions.

In block 1032, the processing system may adjust processing priorities based on latency constraints. For example, the processing system may prioritize time-sensitive tasks to maintain low-latency execution. The processing system may classify tasks based on execution deadlines and dynamically adjust processing order.

In some embodiments, the processing system may apply a tiered scheduling strategy that prioritizes latency-sensitive computations. The processing system may allocate additional processing power to high-priority tasks while deferring lower-priority workloads. The processing system may modify scheduling policies based on real-time performance feedback.

With reference to FIG. 10E, in block 1033, the processing system may track edge node performance and detect network anomalies in real time. For example, the processing system may collect operational metrics, such as processing load, memory consumption, and data transmission rates, from distributed edge nodes. The processing system may analyze historical trends to identify deviations from expected behavior that indicate potential performance degradation or system faults.

In some embodiments, the processing system may apply statistical anomaly detection techniques to refine the identification of network irregularities. For example, the processing system may use a moving z-score analysis to compare real-time network performance metrics against historical baselines. The processing system may generate confidence intervals for detected anomalies and adjust detection thresholds dynamically based on observed trends.

In block 1034, the processing system may apply AI-based anomaly detection techniques to identify unusual patterns in network activity. For example, the processing system may use unsupervised learning models, such as autoencoders or clustering algorithms, to distinguish between normal and anomalous network behavior. The processing system may assign anomaly scores to detected events and trigger alerts when deviations exceed predefined thresholds.

In some embodiments, the processing system may integrate adaptive security policies that modify protocol settings in response to detected threats. For example, the processing system may escalate authentication requirements for nodes exhibiting suspicious activity. The processing system may adjust security certificates or revoke access tokens associated with potentially compromised nodes. The processing system may log all security adjustments in an audit trail to support future forensic analysis.

In block 1035, the processing system may adjust security protocols dynamically to mitigate detected threats. For example, the processing system may modify firewall rules, adjust access control lists, or isolate affected edge nodes to contain potential security breaches. The processing system may implement adaptive threat response policies that modify security measures based on the severity and type of anomaly detected.

In some embodiments, the processing system may incorporate automated failover mechanisms to maintain network resilience in response to security incidents. For example, the processing system may redirect traffic to alternative routes when a firewall adjustment disrupts an existing data path. The processing system may temporarily allocate additional resources to mitigate performance degradation caused by a security reconfiguration.

In block 1036, the processing system may detect and respond to node failures, backhaul disruptions, or topology changes. The processing system may also detect connectivity disruptions or underperformance for connecting devices in a mesh network. For example, the processing system may monitor edge node connectivity status and initiate recovery mechanisms when a node disconnects unexpectedly. The processing system may identify alternative communication routes for affected nodes and redistribute workloads to maintain network functionality.

In some embodiments, the processing system may prioritize failure response strategies based on network impact analysis. For example, the processing system may classify failures as transient, moderate, or severe based on historical recovery rates and the number of affected nodes. The processing system may initiate proactive maintenance if multiple transient failures occur within a short timeframe, indicating potential system instability.

The processing system my initiate a topology change in the mesh network topology by adjusting the routes that different services use to transfer the network to achieve the most optimal performance, adjust to meet SLA requirements, or change to allow other services to use a more efficient route.

In block 1037, the processing system may adjust network topology dynamically to maintain performance. For example, the processing system may reassign node roles, reroute data flows, or modify link aggregation settings to accommodate changing network conditions. The processing system may apply graph-based algorithms to restructure connections among nodes and optimize overall network efficiency.

In some embodiments, the processing system may use reinforcement learning to optimize network topology adjustments. For example, the processing system may analyze historical traffic patterns to determine whether prior topology modifications improved performance. The processing system may reinforce successful adjustments by increasing their selection probability in future optimization cycles.

In block 1038, the processing system may deploy security patches and software updates based on AI-driven risk assessments. For example, the processing system may prioritize updates for nodes identified as vulnerable to newly detected threats. The processing system may schedule patch deployments to minimize service disruption and verify successful installation through post-update validation checks.

In some embodiments, the processing system may determine optimal patch deployment schedules based on network load conditions. For example, the processing system may analyze historical maintenance windows and peak traffic hours to identify periods with minimal service disruption. The processing system may execute updates incrementally, deploying patches to a subset of nodes before full-scale implementation.

With reference to FIG. 10F, in block 1039, the processing system may measure latency, throughput, and error rates across network components. For example, the processing system may analyze transmission delays, data loss percentages, and congestion levels to evaluate overall network performance. The processing system may apply predictive analytics to anticipate future degradation and recommend corrective actions.

In some embodiments, the processing system may integrate multi-agent collaborative learning to refine network performance metrics. For example, the processing system may coordinate with distributed nodes to generate a unified view of latency and throughput measurements. The processing system may use federated averaging techniques to combine localized performance assessments into a single, comprehensive metric.

In block 1040, the processing system may compute AI model performance metrics, including accuracy and confidence levels. For example, the processing system may compare AI-generated predictions to ground-truth data to assess classification performance. The processing system may calculate precision, recall, and F1 scores to quantify model reliability.

In some embodiments, the processing system may adjust AI model evaluation criteria dynamically based on task complexity. For example, the processing system may apply additional metrics, such as mean absolute error (MAE) or Kullback-Leibler divergence, when evaluating probabilistic inference models. The processing system may modify performance thresholds to align with varying computational constraints across edge nodes.

In block 1041, the processing system may apply reinforcement learning techniques to improve system performance over time. For example, the processing system may update AI decision policies based on feedback from recent network events. The processing system may assign reward values to effective optimizations and penalize decisions that negatively impact network performance.

In some embodiments, the processing system may integrate multi-objective reinforcement learning to balance performance optimization goals. For example, the processing system may assign weight values to competing network objectives, such as minimizing latency while preserving energy efficiency. The processing system may adjust reward functions based on the relative importance of different optimization targets.

In block 1042, the processing system may compare real-time data against expected performance baselines. For example, the processing system may maintain historical performance records and detect deviations that indicate potential inefficiencies. The processing system may adjust network parameters dynamically to restore alignment with optimal operational baselines.

In some embodiments, the processing system may incorporate Gaussian process regression to predict performance baseline deviations. For example, the processing system may estimate confidence intervals for expected network conditions and generate alerts when real-time performance deviates from predicted values. The processing system may use these deviations to refine threshold settings for dynamic network adjustments.

In block 1043, the processing system may enhance AI models through continuous training on updated datasets. For example, the processing system may aggregate newly observed network behavior and refine AI inference capabilities. The processing system may implement incremental learning techniques to adapt models without requiring complete retraining.

In some embodiments, the processing system may apply continual learning algorithms to prevent AI model performance degradation due to data drift. For example, the processing system may implement elastic weight consolidation to retain previously learned knowledge while integrating new data. The processing system may monitor model stability and adjust training schedules based on observed accuracy trends.

In block 1044, the processing system may adjust the neural network architecture to improve processing efficiency. For example, the processing system may modify layer configurations, prune redundant connections, or optimize activation functions to reduce computational overhead. The processing system may evaluate real-time inference performance and implement architecture refinements based on observed processing constraints.

In some embodiments, the processing system may optimize neural network structure using evolutionary algorithms. For example, the processing system may apply neural architecture search (NAS) techniques to explore potential layer configurations. The processing system may generate multiple candidate architectures, evaluate their efficiency in real-time conditions, and select the structure with the highest performance-to-resource ratio.

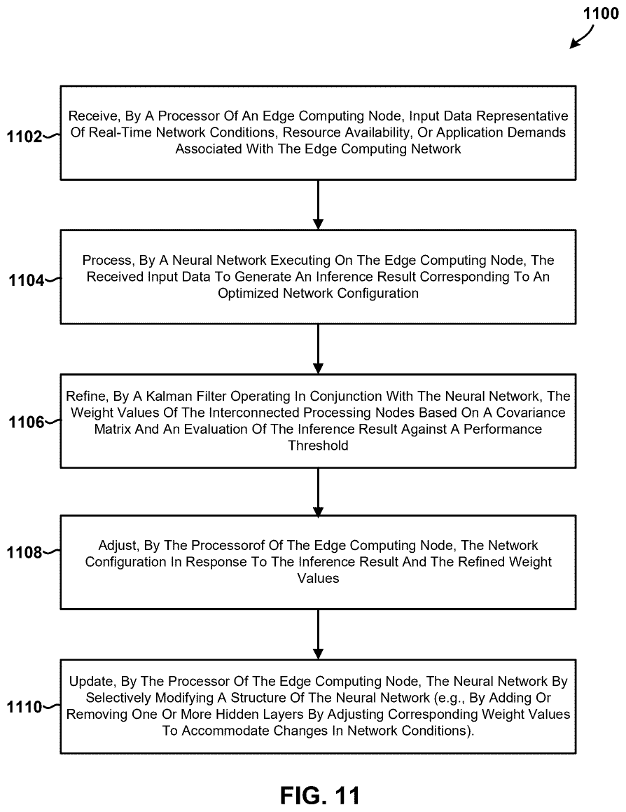

FIG. 11 is a process flow diagram illustrating a method 1100 for dynamically configuring an edge computing network in accordance with some embodiments.

In block 1102, a processor of an edge computing node may receive input data that represents real-time network conditions, resource availability, or application demands associated with the edge computing network. For example, the processing system may collect data from edge nodes, including metrics such as network latency, packet transmission rates, resource utilization, and service-level agreement (SLA) parameters. The processing system may preprocess the data using normalization techniques, such as z-score scaling, to standardize input values and prepare the data for neural network processing. The collected data may include telemetry from distributed devices, ensuring that the neural network receives accurate and current information for decision-making.

In block 1104, the processing system may process the received input data using a neural network executing on the edge computing node to generate an inference result corresponding to an optimized network configuration. For example, the processing system may apply a CNN to analyze spatial patterns in network traffic or a RNN to evaluate temporal dependencies in real-time conditions. The processing system may optimize the inference process by using quantized neural network models, reducing computational overhead while preserving accuracy. The inference result may include recommendations for modifying routing policies, reallocating bandwidth, or prioritizing specific applications based on resource demands.

In block 1106, the processing system may refine the weight values of the interconnected processing nodes in the neural network using a Kalman filter. For example, the processing system may apply a covariance matrix to adjust weights based on a comparison between the inference result and a predefined performance threshold. The processing system may use the Kalman filter to reduce the impact of noisy or inconsistent input data, ensuring that the neural network achieves stable and accurate weight updates. The processing system may dynamically compute the Kalman gain to balance error corrections and preserve convergence rates under varying network conditions.

In block 1108, the processing system may adjust the network configuration based on the inference result and the refined weight values. For example, the processing system may modify routing protocols to redirect traffic along lower-latency paths, reallocate bandwidth to accommodate high-priority applications, or update network security policies to address detected vulnerabilities. The processing system may use software-defined networking (SDN) controllers to implement these adjustments dynamically, minimizing service disruptions. The adjustments may be informed by the refined weights generated in block 1106 so that the changes align with the network's real-time demands and performance goals.

In block 1110, the processing system may update the structure of the neural network to accommodate changes in network conditions. For example, the processing system may add one or more hidden layers to improve the neural network's capacity to handle complex data patterns or remove redundant layers to enhance processing efficiency. The processing system may implement a dynamic pruning mechanism to deactivate underutilized nodes by setting their weights to zero, optimizing resource usage. The processing system may also modify activation functions, such as replacing sigmoid functions with rectified linear unit (ReLU) functions, to accelerate convergence and improve computational efficiency. These updates may allow the neural network to maintain high accuracy while adapting to the evolving requirements of the edge computing environment.

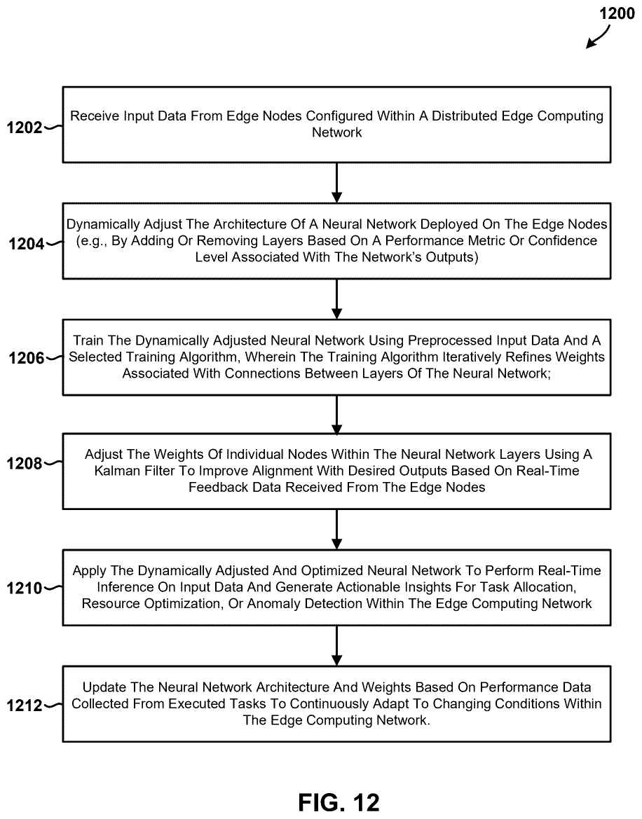

FIG. 12 is a process flow diagram illustrating a method 1200 for enhancing edge computing systems using neural networks and dynamic decision-making in accordance with some embodiments. The processing system may execute the method to preprocess input data, adjust neural network architecture, and optimize performance metrics based on real-time operational conditions.

In block 1202, the processing system may receive input data from edge nodes configured within a distributed edge computing network. For example, the processing system may collect telemetry data that includes network traffic patterns, resource utilization metrics, and latency information. The processing system may preprocess this data to improve uniformity by applying normalization techniques such as min-max scaling or z-score standardization to ensure compatibility with downstream processing.

In some embodiments, the processing system may implement a continuous data ingestion pipeline to collect telemetry data in real time. For example, the processing system may use dimensionality reduction techniques, such as principal component analysis (PCA), to retain the most relevant features while reducing computational overhead. The preprocessed data may then be stored in a high-throughput buffer for subsequent neural network processing.

In block 1204, the processing system may dynamically adjust the architecture of a neural network deployed on the edge nodes by adding or removing layers. For example, the processing system may analyze performance metrics such as inference error rates or confidence levels to determine whether architectural changes are required. If computational demands increase, the processing system may add hidden layers to enhance feature extraction. Conversely, if resource constraints are identified, the processing system may prune redundant layers to improve computational efficiency while maintaining model accuracy.

In some embodiments, the processing system may use reinforcement learning techniques to guide adjustments to the neural network architecture. The processing system may reward configurations that improve accuracy or reduce latency while penalizing those that increase resource usage. This approach may enable the system to adapt autonomously to varying workloads and resource availability.

In block 1206, the processing system may train the dynamically adjusted neural network using preprocessed input data and a selected training algorithm. For example, the processing system may employ optimization methods such as stochastic gradient descent (SGD) or Adam to iteratively refine weights between neural network layers. The processing system may monitor training progress by evaluating metrics such as cross-entropy loss for classification tasks or mean squared error (MSE) for regression tasks.

In some embodiments, the processing system may apply data augmentation during training to improve the robustness of the neural network. For example, the processing system may generate synthetic data variations, such as transformations of input features, to expose the network to a broader range of scenarios. This approach may help reduce overfitting and improve generalization to unseen data during real-world operations.

In block 1208, the processing system may adjust the weights of individual nodes within the neural network layers using a Kalman filter. For example, the processing system may refine weight values by reducing noise and accounting for input data uncertainties. The Kalman filter may compute a Kalman gain to prioritize high-confidence updates and suppress weight changes influenced by outliers.

In some embodiments, the processing system may improve the effectiveness of the Kalman filter by dynamically updating noise covariance parameters based on real-time feedback. For example, the processing system may analyze the variance of input data to adjust these parameters, ensuring stable weight updates under fluctuating conditions. This approach may enhance the convergence rate of the neural network during periods of high variability.

In block 1210, the processing system may apply the dynamically adjusted and optimized neural network to perform real-time inference on input data. For example, the processing system may generate actionable insights for tasks such as resource reallocation, anomaly detection, or load balancing across edge nodes. The processing system may implement a hybrid neural network architecture, combining CNNs for spatial data analysis and RNNs for temporal sequence prediction.

In some embodiments, the processing system may use ensemble learning techniques to improve the accuracy of real-time inference. For example, the processing system may combine predictions from multiple neural network models trained on distinct data subsets, weighting each model's contribution based on its historical reliability. This method may enhance the consistency of actionable insights.

In block 1212, the processing system may update the neural network architecture and weights based on performance data collected from executed tasks. For example, the processing system may integrate feedback from tasks such as resource allocation, anomaly detection, or latency optimization to refine the neural network. The processing system may employ continuous learning techniques, including incremental updates or federated learning, to update the model without requiring full retraining.

In some embodiments, the processing system may monitor long-term performance trends to guide updates to the neural network. For example, the processing system may analyze metrics such as latency, prediction accuracy, and resource utilization to identify patterns necessitating structural modifications or retraining. The processing system may implement asynchronous updates to reduce disruption to ongoing network operations.

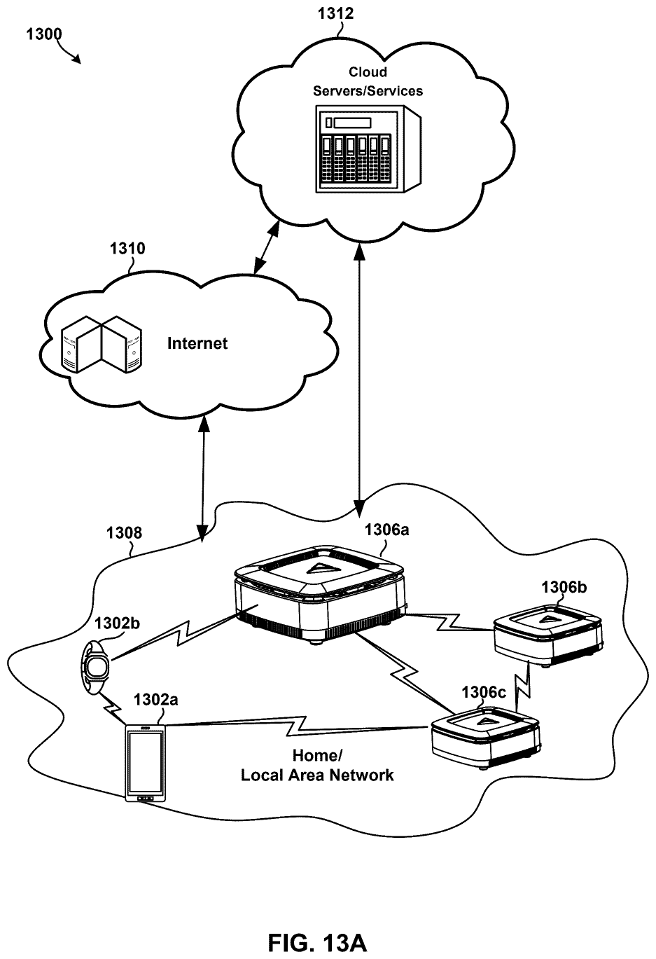

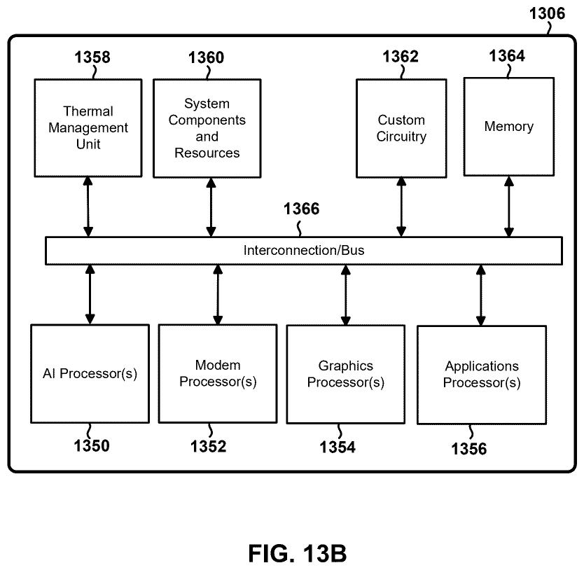

FIG. 13A illustrates an example edge computing system 1300 suitable for implementing various embodiments. The edge computing system 1300 includes user computing devices 1302a and 1302b and edge devices 1306a to 1306c, which may operate within a home or local area network 1308. The network 1308 may be linked to the internet 1310 and cloud servers or services 1312 via wired or wireless communication links. The user computing devices 1302a and 1302b or edge devices 1306a to 1306c may include one or more processors configured to perform the functionalities described with reference to the edge computing system 1300.

The edge computing system 1300 may address computational and resource limitations on user computing devices 1302a and 1302b when executing complex software applications. These limitations may affect performance, latency, and energy consumption, reducing the efficiency of certain applications. The edge computing system 1300 may mitigate these issues by offloading computationally intensive tasks from user computing devices 1302a and 1302b to edge devices 1306a to 1306c or cloud servers 1312. For example, the system may delegate key components of software applications to the edge devices, reducing the processing load on user computing devices.

The edge computing system 1300 may share resources such as hardware and software among multiple edge devices 1306a to 1306c, operating as a computing mesh. The computing mesh may dynamically allocate resources based on workloads, computation requirements, and performance constraints. This approach may improve the performance of latency-sensitive applications by balancing tasks across edge devices.

The edge devices 1306a to 1306c may include homogeneous or heterogeneous computing architectures. For example, homogeneous edge devices may use identical hardware platforms and software environments, while heterogeneous edge devices may employ different operating systems, hardware architectures, and storage capacities. Some embodiments may incorporate edge devices into a processor cluster architecture, which may include synchronous or asynchronous processing configurations.

FIG. 13B illustrates an edge device 1306 including interconnected modules designed for specialized and general-purpose computations in distributed edge computing systems. The edge device 1306 includes an artificial intelligence (AI) processor 1350, a modem processor 1352, a graphics processor 1354, an application processor 1356, memory 1364, custom circuitry 1362, system components and resources 1360, a thermal management unit 1358, and an interconnection or bus module 1366. The edge device 1306 may perform arithmetic, logical, control, and input/output (I/O) operations through its processing modules.

The AI processor 1350 may include specialized components for executing machine learning models and artificial intelligence algorithms. For example, the AI processor may incorporate tensor processing units (TPUs) optimized for performing matrix multiplications in DNNs. The AI processor may improve inference and training tasks by executing operations such as activation functions, tensor manipulation, and convolutional computations. These capabilities may support edge-based applications such as real-time anomaly detection, natural language processing, and object recognition.

In some embodiments, the AI processor 1350 may include a neural processing unit (NPU), a neural network processing unit (NNPU), or similar specialized hardware for accelerating machine learning computations. These components may optimize neural network operations such as matrix multiplication and weight updates, enhancing performance for inference and training workloads.

Each processor 1350, 1352, 1354, and 1356 may include one or more independent cores capable of performing tasks in parallel. For example, the edge device 1306 may include processors configured to operate different operating systems, including FreeBSD, Linux, or Windows. These processors may operate within a processor cluster to support distributed computing tasks.

The processors 1350, 1352, 1354, and 1356 may interact with memory 1364, system components and resources 1360, custom circuitry 1362, and the thermal management unit 1358 via the interconnection or bus module 1366. This module may implement a bus architecture or reconfigurable logic gates, providing efficient communication through high-performance interconnects such as networks-on-chip (NoCs).

The thermal management unit 1358 may monitor and regulate the temperature and power consumption of the edge device 1306. The unit may dynamically adjust the performance of the processors to prevent overheating and maintain system stability under varying workloads.

System components and resources 1360 and custom circuitry 1362 may handle sensor data processing, analog-to-digital conversions, and wireless communications. For example, they may include power amplifiers, voltage regulators, temperature sensors, memory controllers, and oscillators. The custom circuitry 1362 may provide interfaces to other computing systems or peripherals, extending the edge device's capabilities.

The edge device 1306 may also include an input/output module (not shown) to communicate with external components such as clocks and voltage regulators. These external resources may be shared across internal processors and cores within the edge device.

In addition to edge device 1306, various embodiments may be implemented in a wide variety of computing systems, including SOCs, SIPs, single processors, multiple processors, multicore processors, or combinations thereof. That is, the described embodiments may extend beyond edge device 1306 to include a wide range of computing systems, such as system-on-chip (SOC) devices, system-in-package (SIP) modules, single or multicore processors, and combinations of these configurations. These systems may integrate similar functionality to support distributed edge computing environments.

The edge computing system may be made up of multiple edge computing systems all connected in a mesh environment. The edge computing devices may be a heterogeneous hardware environment where different edge computing devices have different capabilities depending on their internal architectures which includes CPU type, RAM, storage capabilities, wireless and wired capabilities as well as kernel capabilities and version. The heterogeneous environment can also include edge devices that have the same identical platforms but operating with different software versions.

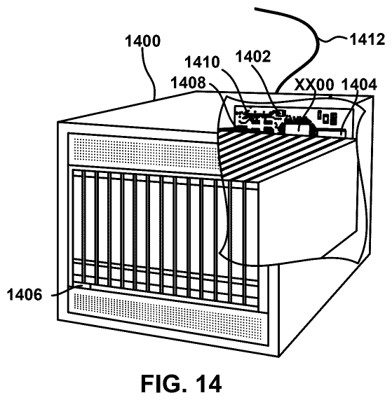

All or portions of some embodiments may be implemented in the cloud or on a variety of commercially available computing devices, such as the server computing device 1400 illustrated in FIG. 14. The server device 1400 may include a SoC 1400 or one or more processors 1402 (e.g., multi-core processor, etc.) coupled to memory 1404, storage interfaces 1406 such as USB ports and NVMe slots, and network access ports 1408 that allow data connections through a network interface card (NIC) 1410 and a communication network 1412 (e.g., an Internet Protocol (IP) network) connected to other network elements.

For the sake of clarity and ease of presentation, the methods discussed in this application are presented as separate embodiments. While each method is delineated for illustrative purposes, it should be clear to those skilled in the art that various combinations or omissions of these methods, blocks, operations, etc. could be used to achieve a desired result or a specific outcome. It should also be understood that the descriptions herein do not preclude the integration or adaptation of different embodiments of the methods, blocks, operations, etc. from producing a modified or alternative result or solution. The presentation of individual methods, blocks, operations, etc. should not be interpreted as mutually exclusive, limiting, or as being required unless expressly recited as such in the claims.

The processors discussed in this application may be any programmable microprocessor, microcomputer, or a combination of multiple processor chips configured by software instructions (applications) to perform diverse functions, including those of the various embodiments described herein. Severs 900 often include multiple processors, with dedicated processors for specific tasks such as managing cloud computing operations, data analytics, or wireless communication functions. Software applications may be stored in the internal memory before being accessed and executed by the processor. Modern processors may include extensive internal memory, often augmented with fast access cache memory, to efficiently store and process application software instructions.

As used in this application, terminology such as “component,” “module,” “system,” etc., is intended to encompass a computer-related entity. These entities may involve, among other possibilities, hardware, firmware, a blend of hardware and software, software alone, or software in an operational state. As examples, a component may encompass a running process on a processor, the processor itself, an object, an executable file, a thread of execution, a program, or a computing device. To illustrate further, both an application operating on a computing device and the computing device itself may be designated as a component. A component might be situated within a single process or thread of execution or could be distributed across multiple processors or cores. In addition, these components may operate based on various non-volatile computer-readable media that store diverse instructions and/or data structures. Communication between components may take place through local or remote processes, function, or procedure calls, electronic signaling, data packet exchanges, memory interactions, among other known methods of network, computer, processor, or process-related communications.

A variety of memory types and technologies, both currently available and anticipated for future development, may be incorporated into systems and computing devices that implement the various embodiments. These memory technologies may include non-volatile random-access memories (NVRAM) such as magnetoresistive RAM (MRAM), resistive random-access memory (ReRAM or RRAM), phase-change memory (PCM, PC-RAM, or PRAM), ferroelectric RAM (FRAM), spin-transfer torque magnetoresistive RAM (STT-MRAM), and three-dimensional cross point (3D XPoint) memory. Non-volatile or read-only memory (ROM) technologies may also be included, such as programmable read-only memory (PROM), field programmable read-only memory (FPROM), and one-time programmable non-volatile memory (OTP NVM). Volatile random-access memory (RAM) technologies may further be utilized, including dynamic random-access memory (DRAM), double data rate synchronous dynamic random-access memory (DDR SDRAM), static random-access memory (SRAM), and pseudostatic random-access memory (PSRAM). Additionally, systems and computing devices implementing these embodiments may use solid-state non-volatile storage mediums, such as FLASH memory. The aforementioned memory technologies may store instructions, programs, control signals, and/or data for use in computing devices, system-on-chip (SoC) components, or other electronic systems. Any references to specific memory types, interfaces, standards, or technologies are provided for illustrative purposes and do not limit the claims to any particular memory system or technology unless explicitly recited in the claim language.

The foregoing method descriptions and the process flow diagrams are provided merely as illustrative examples and are not intended to require or imply that the blocks of the various aspects must be performed in the order presented. As may be appreciated by one of skill in the art the order of steps in the foregoing aspects may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithmic steps described in connection with the aspects disclosed herein may be implemented as electronic hardware, computer software, or combinations of both. To clearly illustrate the interchangeability of hardware and software, various components, blocks, modules, circuits, and steps have been described in terms of their functionality. Whether such functionality is implemented as hardware or software may depend on the specific application and the design constraints of the overall system. Skilled artisans may implement the described functionality in different ways for each particular application, and such implementation decisions should not be interpreted as limiting or altering the scope of the claims unless explicitly recited in the claim language.

The hardware used to implement the various illustrative logics, logical blocks, modules, and circuits described in connection with the embodiments disclosed herein may include or be performed by a general-purpose processor, a digital signal processor (DSP), an application-specific integrated circuit (ASIC), a field-programmable gate array (FPGA), a graphics processing unit (GPU), a tensor processing unit (TPU), or other programmable logic devices, discrete gate or transistor logic, discrete hardware components, or any combination thereof, designed to perform the functions described. A general-purpose processor may be a microprocessor, or alternatively, it may be any conventional processor, controller, microcontroller, or state machine. A processor may also be implemented as a combination of computing devices, such as a DSP combined with a microprocessor, multiple microprocessors, one or more microprocessors used in conjunction with a DSP core, a GPU, or AI accelerators such as TPUs. Alternatively, some operations or methods may be performed by circuitry designed specifically for a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module that resides on a non-transitory computer-readable or processor-readable storage medium. Non-transitory computer-readable or processor-readable storage media include any storage media that may be accessed by a computer or processor. By way of example, but not limitation, such non-transitory computer-readable or processor-readable media may include RAM, ROM, EEPROM, flash memory, SSDs, NVMe drives, 3D NAND flash, or any other medium capable of storing program code in the form of instructions or data structures that may be accessed by a computer. Cloud-based storage solutions, including infrastructure-as-a-service (IaaS) platforms, may provide scalable and distributed options for storing and accessing program code. In addition, the operations of a method or algorithm may reside as one or more sets of instructions or code on a non-transitory processor-readable or computer-readable medium, which may be incorporated into a computer program product. Emerging technologies, such as quantum computing storage media and blockchain-based storage solutions, may enhance data integrity and security. AI and ML-improved hardware accelerators, such as GPUs, TPUs, and other dedicated processing units, may be used to efficiently execute complex algorithms.

The preceding description of the disclosed aspects is provided to enable any person skilled in the art to make or use the claims. Various modifications to these aspects may be apparent to those skilled in the art, and the generic principles defined herein may be applied to other aspects without departing from the scope of the claims. Thus, the present disclosure is not intended to be limited to the aspects shown herein but is to be accorded the widest scope consistent with the following claims and the principles and novel features disclosed herein.

What is claimed is:

1. A computing device, comprising:
a processor configured to:
monitor real-time model accuracy of a neural network by using a feedback loop configured to detect changes in inference accuracy;
dynamically adjust a structure of the neural network by adding or removing hidden layers based on monitored error rates and predetermined computational constraints;
compute a Kalman gain based on monitored error rates, and determining weight adjustments for the neural network based on the computed Kalman gain;
incrementally update weight matrices of the neural network based on the determined weight adjustments;
store incremental weight adjustments of the neural network in memory for performing low-bandwidth model updates;
store inference results generated by the neural network and refined weights in an inference result database;
periodically update pre-trained models associated with the neural network based on the stored incremental weight adjustments; and
apply predictive holistic inference logic (PHIL) to the inference results stored in the inference result database to produce enhanced inference accuracy.

2. The computing device of claim 1, wherein the processor is configured to monitor real-time model accuracy by using the feedback loop by tracking model performance metrics by repeatedly analyzing inference accuracy in response to changes in real-time network conditions experienced by the neural network.

3. The computing device of claim 2, wherein the processor is further configured to:
compare predicted outputs generated by the neural network to actual network behavior to identify deviations between predicted outputs and actual network behavior; and
trigger recalibration of the neural network in response to determining that an identified deviation exceeds a predefined accuracy threshold value.

4. The computing device of claim 3, wherein the processor is further configured to dynamically adjust the predefined accuracy threshold value based on measured variability in network conditions to reduce the frequency of recalibrations of the neural network.

5. The computing device of claim 1, wherein the processor is configured to dynamically adjust the structure of the neural network by adding or removing hidden layers based on the monitored error rates and predetermined computational constraints by:
analyzing neuron activation patterns of at least one hidden layer of the neural network to determine whether the at least one hidden layer contributes to inference accuracy; and
improving computational efficiency of the neural network by removing the at least one hidden layer from the structure of the neural network in response to determining that the at least one hidden layer does not substantially contribute to inference accuracy.

6. The computing device of claim 5, wherein the processor is further configured to:
analyze neuron activation patterns of the at least one hidden layer comprises analyzing neuron activation levels to determine whether the at least one hidden layer consistently exhibits low activation during inference operations; and
remove the at least one hidden layer comprises removing the at least one hidden layer from the neural network structure in response to determining that the at least one hidden layer consistently exhibits low activation.

7. The computing device of claim 1, wherein the processor is configured to dynamically adjust the structure of the neural network by adding or removing hidden layers based on the monitored error rates and predetermined computational constraints by implementing a self-pruning mechanism configured to identify and remove neurons from hidden layers exhibiting low activation gradients.

8. The computing device of claim 1, wherein the processor is configured to dynamically adjust the structure of the neural network by adding or removing hidden layers based on the monitored error rates and predetermined computational constraints by replacing an activation function used by neurons within hidden layers with an alternative activation function selected from a rectified linear unit (ReLU) or a Leaky ReLU to increase learning efficiency.

9. The computing device of claim 1, wherein the processor is configured to compute the Kalman gain based on monitored error rates and determining weight adjustments based on the computed Kalman gain by:
computing the Kalman gain by integrating weighted error estimates derived from real-time inference feedback; and
refining weight adjustments of the neural network based on the computed Kalman gain to improve convergence rates during inference operations.

10. The computing device of claim 1, wherein the processor is configured to storing incremental weight adjustments of the neural network in memory for performing low-bandwidth model updates further by applying federated learning techniques to distribute incremental weight differentials instead of distributing full neural network model updates.

11. The computing device of claim 1, wherein the processor is configured to updating pre-trained models associated with the neural network periodically based on stored incremental weight adjustments by:
incorporating newly observed network traffic patterns and associated device behavior into an existing architecture of the pre-trained models; and
executing asynchronous updates of the pre-trained models to maintain uninterrupted real-time inference operations.

12. The computing device of claim 1, wherein the processor is configured to apply predictive holistic inference logic (PHIL) to the inference results stored in the inference result database to produce enhanced inference accuracy by integrating multiple inference sources associated with the neural network to refine model predictions through a consensus-based approach.

13. A method for adaptive edge computing using artificial intelligence (AI), the method comprising:
monitoring real-time model accuracy of a neural network by using a feedback loop configured to detect changes in inference accuracy;
dynamically adjusting a structure of the neural network by adding or removing hidden layers based on monitored error rates and predetermined computational constraints;
computing a Kalman gain based on monitored error rates, and determining weight adjustments for the neural network based on the computed Kalman gain;
incrementally updating weight matrices of the neural network based on the determined weight adjustments;
storing incremental weight adjustments of the neural network in memory for performing low-bandwidth model updates;
storing inference results generated by the neural network and refined weights in an inference result database;
periodically updating pre-trained models associated with the neural network based on the stored incremental weight adjustments; and
applying predictive holistic inference logic (PHIL) to the inference results stored in the inference result database to produce enhanced inference accuracy.

14. The method of claim 13, wherein monitoring real-time model accuracy by using the feedback loop comprises tracking model performance metrics by repeatedly analyzing inference accuracy in response to changes in real-time network conditions experienced by the neural network.

15. The method of claim 14, further comprising:
comparing predicted outputs generated by the neural network to actual network behavior to identify deviations between predicted outputs and actual network behavior; and
triggering recalibration of the neural network in response to determining that an identified deviation exceeds a predefined accuracy threshold value.

16. The method of claim 15, further comprising dynamically adjusting the predefined accuracy threshold value based on measured variability in network conditions to reduce the frequency of recalibrations of the neural network.

17. The method of claim 13, wherein dynamically adjusting the structure of the neural network by adding or removing hidden layers based on the monitored error rates and predetermined computational constraints comprises:
analyzing neuron activation patterns of at least one hidden layer of the neural network to determine whether the at least one hidden layer contributes to inference accuracy; and
improving computational efficiency of the neural network by removing the at least one hidden layer from the structure of the neural network in response to determining that the at least one hidden layer does not substantially contribute to inference accuracy.

18. The method of claim 17, wherein:
analyzing neuron activation patterns of the at least one hidden layer comprises analyzing neuron activation levels to determine whether the at least one hidden layer consistently exhibits low activation during inference operations; and
removing the at least one hidden layer comprises removing the at least one hidden layer from the neural network structure in response to determining that the at least one hidden layer consistently exhibits low activation.

19. The method of claim 13, wherein dynamically adjusting the structure of the neural network by adding or removing hidden layers based on the monitored error rates and predetermined computational constraints comprises implementing a self-pruning mechanism configured to identify and remove neurons from hidden layers exhibiting low activation gradients.

20. The method of claim 13, wherein dynamically adjusting the structure of the neural network by adding or removing hidden layers based on the monitored error rates and predetermined computational constraints comprises replacing an activation function used by neurons within hidden layers with an alternative activation function selected from a rectified linear unit (ReLU) or a Leaky ReLU to increase learning efficiency.

21. The method of claim 13, wherein computing the Kalman gain based on monitored error rates and determining weight adjustments based on the computed Kalman gain comprises:
computing the Kalman gain by integrating weighted error estimates derived from real-time inference feedback; and
refining weight adjustments of the neural network based on the computed Kalman gain to improve convergence rates during inference operations.

22. The method of claim 13, wherein storing incremental weight adjustments of the neural network in memory for performing low-bandwidth model updates further comprises applying federated learning techniques to distribute incremental weight differentials instead of distributing full neural network model updates.

23. The method of claim 13, wherein updating pre-trained models associated with the neural network periodically based on stored incremental weight adjustments comprises:
incorporating newly observed network traffic patterns and associated device behavior into an existing architecture of the pre-trained models; and
executing asynchronous updates of the pre-trained models to maintain uninterrupted real-time inference operations.

24. The method of claim 13, wherein applying predictive holistic inference logic (PHIL) to the inference results stored in the inference result database to produce enhanced inference accuracy comprises integrating multiple inference sources associated with the neural network to refine model predictions through a consensus-based approach.

25. A non-transitory processor-readable storage medium having stored thereon processor-executable instructions configured to cause a processing system in a computing device to perform operations for adaptive edge computing using artificial intelligence (AI), the method comprising:
monitoring real-time model accuracy of a neural network by using a feedback loop configured to detect changes in inference accuracy;
dynamically adjusting a structure of the neural network by adding or removing hidden layers based on monitored error rates and predetermined computational constraints;
computing a Kalman gain based on monitored error rates, and determining weight adjustments for the neural network based on the computed Kalman gain;
incrementally updating weight matrices of the neural network based on the determined weight adjustments;
storing incremental weight adjustments of the neural network in memory for performing low-bandwidth model updates;
storing inference results generated by the neural network and refined weights in an inference result database;
periodically updating pre-trained models associated with the neural network based on the stored incremental weight adjustments; and
applying predictive holistic inference logic (PHIL) to the inference results stored in the inference result database to produce enhanced inference accuracy.

26. The non-transitory processor-readable storage medium of claim 25, wherein the stored processor-executable instructions are configured to cause the processing system to perform operations such that monitoring real-time model accuracy by using the feedback loop comprises tracking model performance metrics by repeatedly analyzing inference accuracy in response to changes in real-time network conditions experienced by the neural network.

27. The non-transitory processor-readable storage medium of claim 26, wherein the stored processor-executable instructions are configured to cause the processing system to perform operations further comprising:
comparing predicted outputs generated by the neural network to actual network behavior to identify deviations between predicted outputs and actual network behavior; and
triggering recalibration of the neural network in response to determining that an identified deviation exceeds a predefined accuracy threshold value.

28. The non-transitory processor-readable storage medium of claim 27, wherein the stored processor-executable instructions are configured to cause the processing system to perform operations further comprising dynamically adjusting the predefined accuracy threshold value based on measured variability in network conditions to reduce the frequency of recalibrations of the neural network.

29. The non-transitory processor-readable storage medium of claim 25, wherein the stored processor-executable instructions are configured to cause the processing system to perform operations such that dynamically adjusting the structure of the neural network by adding or removing hidden layers based on the monitored error rates and predetermined computational constraints comprises:
analyzing neuron activation patterns of at least one hidden layer of the neural network to determine whether the at least one hidden layer contributes to inference accuracy; and
improving computational efficiency of the neural network by removing the at least one hidden layer from the structure of the neural network in response to determining that the at least one hidden layer does not substantially contribute to inference accuracy.

30. The non-transitory processor-readable storage medium of claim 29, wherein the stored processor-executable instructions are configured to cause the processing system to perform operations such that:
analyzing neuron activation patterns of the at least one hidden layer comprises analyzing neuron activation levels to determine whether the at least one hidden layer consistently exhibits low activation during inference operations; and
removing the at least one hidden layer comprises removing the at least one hidden layer from the neural network structure in response to determining that the at least one hidden layer consistently exhibits low activation.

31. The non-transitory processor-readable storage medium of claim 25, wherein the stored processor-executable instructions are configured to cause the processing system to perform operations such that dynamically adjusting the structure of the neural network by adding or removing hidden layers based on the monitored error rates and predetermined computational constraints comprises implementing a self-pruning mechanism configured to identify and remove neurons from hidden layers exhibiting low activation gradients.

32. The non-transitory processor-readable storage medium of claim 25, wherein the stored processor-executable instructions are configured to cause the processing system to perform operations such that dynamically adjusting the structure of the neural network by adding or removing hidden layers based on the monitored error rates and predetermined computational constraints comprises replacing an activation function used by neurons within hidden layers with an alternative activation function selected from a rectified linear unit (ReLU) or a Leaky ReLU to increase learning efficiency.

33. The non-transitory processor-readable storage medium of claim 25, wherein the stored processor-executable instructions are configured to cause the processing system to perform operations such that computing the Kalman gain based on monitored error rates and determining weight adjustments based on the computed Kalman gain comprises:
computing the Kalman gain by integrating weighted error estimates derived from real-time inference feedback; and
refining weight adjustments of the neural network based on the computed Kalman gain to improve convergence rates during inference operations.

34. The non-transitory processor-readable storage medium of claim 25, wherein the stored processor-executable instructions are configured to cause the processing system to perform operations such that storing incremental weight adjustments of the neural network in memory for performing low-bandwidth model updates further comprises applying federated learning techniques to distribute incremental weight differentials instead of distributing full neural network model updates.

35. The non-transitory processor-readable storage medium of claim 1, wherein the stored processor-executable instructions are configured to cause the processing system to perform operations such that updating pre-trained models associated with the neural network periodically based on stored incremental weight adjustments comprises:
incorporating newly observed network traffic patterns and associated device behavior into an existing architecture of the pre-trained models; and
executing asynchronous updates of the pre-trained models to maintain uninterrupted real-time inference operations.

36. The non-transitory processor-readable storage medium of claim 25, wherein the stored processor-executable instructions are configured to cause the processing system to perform operations such that applying predictive holistic inference logic (PHIL) to the inference results stored in the inference result database to produce enhanced inference accuracy comprises integrating multiple inference sources associated with the neural network to refine model predictions through a consensus-based approach.
